(19) United States
(12) Patent Application Publication
(10) Pub. No.: US 2024/0255538 A1
(43) Pub. Date: Aug. 1, 2024

(54) LIQUID DISPENSING DEVICE FOR FILLING MULTIPLE CONTAINERS

(71) Applicant: Agilent Technologies, Inc., Santa Clara, CA (US)

(72) Inventors: Jonathan Irribarren, Fremont, CA (US); Lawrence D. Andrews, Scotts Valley, CA (US)

(21) Appl. No.: 18/103,449

(22) Filed: Jan. 30, 2023

(51) Int. Cl. G01N 35/10

(52) U.S. Cl. CPC G01N 35/1074; G01N 35/1011; G01N 35/1016

(57) ABSTRACT

A liquid dispensing device provides an input flow of liquid from a single inlet into an internal manifold, and distributes or divides the input flow from the manifold into a group of individual liquid circuits that direct respective output flows to outlets, from which controlled volumes of liquid can be dispensed into respective containers such as the wells of a multi-well plate. The volume of liquid dispensed into one container may be different from that dispensed into another container. Each liquid circuit may include a valve that regulates the liquid flow in that liquid circuit, which may be based on feedback from flow rate sensors. Two or more liquid dispensing devices may be stacked horizontally to provide additional unique liquid circuits and different liquids if desired.

### TECHNICAL FIELD

The present invention generally relates to dispensing liquids from a source to multiple containers, such as into the wells of a multi-well plate. A device for dispensing the liquids may be implemented in laboratory hardware, for example, which may be automated.

### BACKGROUND

Many methods involving the processing of liquids or materials carried by liquids benefit from the use of liquid handling systems configured to enable high-throughput processing and utilize a high degree of automation, in particular systems configured to dispense or fill containers such as the wells of a multi-well plate. Such processing may involve the detection, measurement, or assaying of a large number of chemical or biological samples in parallel, or the synthesis of chemical or biological products from a large number of precursor materials. For dispensing operations, liquid handling systems have been developed that utilize a motorized pipettor head or inkjet printer-type head capable of dispensing small volumes of liquids into the individual wells of multi-well plates loaded onto such systems. Such known systems may also utilize a robot to load and unload multi-well plates into and from the systems. The known systems may exhibit problems with performance, reliability, and high-throughput capability. For example, the known systems may be overly sensitive to variable conditions that affect liquid flow such a variable viscosity and clogging events, and may be mechanically complex and/or prone to leaking or other failures. In addition, the known systems may not perform liquid dispensing operations as rapidly as desired, and may not be capable of chemical or biological synthesis or analysis on a large enough scale in the context of the number of samples involved. Moreover, for systems that rely on the use of single-use (disposable) pipette tips, the added cost and waste associated with the need to frequently replace the pipette tips is undesirable in some applications.

Therefore, there is an ongoing need for further developments in liquid dispensing devices, systems, and methods.

### SUMMARY

To address the foregoing needs, in whole or in part, and/or other needs that may have been observed by persons skilled in the art, the present disclosure provides methods, processes, systems, apparatus, instruments, and/or devices, as described by way of example in implementations set forth below.

In some aspects of the present disclosure, a liquid dispensing device provides a flow of liquid from a single inlet into an internal manifold, and distributes the flow from the manifold into a group of unique liquid circuits or channels that direct respective flows to outlets, from which controlled volumes of liquid can be dispensed into respective containers such as the wells of a multi-well plate. The liquid circuits or channels are defined by respective liquid conduits (e.g., tubes, pipes, etc.) that communicate with the common manifold. Each liquid circuit or channel includes a valve that regulates the liquid flow in that liquid circuit. Two or more liquid dispensing devices may be stacked horizontally to provide additional unique liquid circuits, and supply different liquids, if desired. The liquid dispensing device(s) may be integrated with a larger system or apparatus (e.g., laboratory automation tool or instrument) that is configured for liquid dispensing and possibly any number of other liquid processing tasks (e.g., mixing, dilution, buffering, other types of liquid conditioning, (bio)chemical reaction, (bio)chemical synthesis, chemical or enzymatic cleaving, hybridization, analytical separation and/or collection of sample components, purification, detection/measurement of analytes, etc.).

According to one implementation, a liquid dispensing device includes: a housing enclosing a device interior; a manifold disposed in the device interior and comprising an inlet; a plurality of conduits disposed in the device interior and communicating with the manifold, and comprising a plurality of horizontally spaced outlets, respectively; and a plurality of actively controllable valves respectively disposed in the conduits, the valves configured to control respective flows of liquid through the conduits, wherein the liquid dispensing device defines a common liquid input flow path in the manifold, and a plurality of liquid output flow paths running from the manifold, through the respective conduits and to the respective outlets.

In an implementation, the liquid dispensing device includes one or more flow rate sensors configured to measure flow rate in the common liquid input flow path and/or flow rates in the output flow paths. As an example, the measurement data produced by the flow rate sensor(s) may be utilized to adjust the flow rate in one or more of the conduits and/or the volume dispensed from one or more of the conduits.

According to another implementation, a liquid dispensing system includes: a plurality of liquid dispensing devices according to any of the implementations disclosed herein, wherein the liquid dispensing devices are horizontally stacked such that the outlets of the liquid dispensing devices are arranged in a two-dimensional array.

According to another implementation, a liquid dispensing system includes: one or more liquid dispensing devices according to any of the implementations disclosed herein; and a stage movable along one or more axes, and configured to move a plurality of containers (e.g., a multi-well plate) to and from the liquid dispensing device(s).

According to another implementation, a method for dispensing liquids includes: providing a liquid dispensing device comprising a manifold, a plurality of conduits, and a plurality of valves respectively disposed in the conduits, wherein the manifold comprises an inlet and the plurality of conduits comprise a plurality of outlets, respectively; providing a plurality of containers; selecting selected containers of the plurality of containers to receive the liquid; determining volumes of the liquid to be respectively dispensed into the selected containers, wherein the volume determined for at least one of the selected containers differs from the volume determined for at least one other of the selected containers; flowing the liquid through the inlet and the manifold, and into the conduits; and dispensing the liquid according to the determined volumes into the selected containers from corresponding outlets of the plurality of outlets, by controlling the valves.

According to another implementation, a method for dispensing liquids includes: providing a liquid dispensing device comprising a manifold, a plurality of conduits, and a plurality of valves respectively disposed in the conduits, wherein the manifold comprises an inlet and the plurality of conduits comprise a plurality of outlets, respectively; dispensing liquid from one or more selected conduits of the plurality of conduits; measuring respective flow rates of the liquid in the selected conduits; for each selected conduit, determining if the measured flow rate deviates from a target flow rate or a target flow rate range set for the selected conduit; for each selected conduit in which the measured flow rate is determined to deviate from the target flow rate or the target flow rate range for that selected conduit, adjusting a valve operation of the valve in the selected conduit.

In an implementation, the dispensing of the determined volumes includes controlling the valves based on one or more flow rates measured in the inlet and/or manifold and/or one or more of the conduits.

According to another implementation, a non-transitory computer-readable medium includes instructions stored thereon, that when executed on a processor, control or perform one or more of the steps of selecting, flowing, and dispensing according to any of the methods disclosed herein.

According to another implementation, a liquid dispensing system includes the non-transitory computer-readable storage medium.

Other devices, apparatus, systems, methods, features and advantages of the invention will be or will become apparent to one with skill in the art upon examination of the following figures and detailed description. It is intended that all such additional systems, methods, features and advantages be included within this description, be within the scope of the invention, and be protected by the accompanying claims.

### BRIEF DESCRIPTION OF THE DRAWINGS

The invention can be better understood by referring to the following figures. The components in the figures are not necessarily to scale, emphasis instead being placed upon illustrating the principles of the invention. In the figures, like reference numerals designate corresponding parts throughout the different views.

FIG. 1 is a schematic view of an example of a liquid dispensing device according to an implementation of the present disclosure.

FIG. 2 is a perspective view of an example of a multi-well plate that may be utilized with a liquid dispensing device according to an implementation of the present disclosure.

FIG. 3 is a schematic view of an example of a liquid conduit (or a lower end portion of the conduit) and a liquid output component according to an implementation of the present disclosure.

FIG. 4 is a schematic view of a liquid dispensing system according to some implementations of the present disclosure.

FIG. 5 is a schematic view of an example of a system controller according to an implementation of the present disclosure.

FIG. 6 is a flow diagram illustrating an example of a method for dispensing a liquid according to an implementation of the present disclosure.

FIG. 7 is a flow diagram illustrating another example of a method for dispensing a liquid according to an implementation of the present disclosure

The illustrations in all of the drawing figures are considered to be schematic, unless specifically indicated otherwise.

### DETAILED DESCRIPTION

In this disclosure, all “aspects,” “examples,” “embodiments,” and “implementations” described are considered to be non-limiting and non-exclusive. Accordingly, the fact that a specific “aspect,” “example,” “embodiment,” or “implementation” is explicitly described herein does not exclude other “aspects,” “examples,” “embodiments,” and “implementations” from the scope of the present disclosure even if not explicitly described. In this disclosure, the terms “aspect,” “example,” “embodiment,” and “implementation” are used interchangeably, i.e., are considered to have interchangeable meanings.

In this disclosure, the term “substantially,” “approximately,” or “about,” when modifying a specified numerical value, may be taken to encompass a range of values that include +/−10% of such numerical value.

In this disclosure, the term “liquid” encompasses a single liquid-phase composition or a mixture or blend of two or more liquid-phase compositions. Examples of a liquid include, but are not limited to, a solution, a suspension, a colloid, or an emulsion. A liquid may contain or carry solid particles (e.g., inorganic particulates, whole biological cells or lysed cell components, etc.) and/or gas or vapor bubbles.

In this disclosure, the term “conduit” generally refers to any type of structure enclosing an interior space that defines a repeatable path for fluid to flow from one point (e.g., an inlet of the conduit) to another point (e.g., an outlet of the conduit). A conduit generally includes one or more walls defining a pipe, tube, capillary, channel, manifold, chamber, or the like. The cross-section (or cross-sectional flow area) of the inner bore or lumen of a conduit may have any shape such as, for example, circular, elliptical, or polygonal. A conduit may be formed by any appropriate technique now known or later developed. A conduit may be formed from a variety of materials such as, for example, fused silica, glasses, ceramics, polymers, and metals. In some implementations, the material forming the conduit is optically transparent for a purpose such as performing an optics-based measurement or sample analysis, detecting or identifying a substance flowing through the conduit, enabling a user to observe flows and/or internal components in the conduit, etc. Alternatively, the conduit may include an optically transparent window for such purposes.

In this disclosure, the term “(bio)chemical compound” encompasses chemical compounds and biological compounds.

A chemical compound may be, for example, a small molecule or a high molecular-weight molecule (e.g., a polymer, carbohydrate, etc.).

A biological compound may be, for example, a biopolymer. Examples include, but are not limited to, nucleic acids (or polynucleotides). The term “nucleic acid” may refer to a biopolymer of any length, e.g., greater than about 2 bases, greater than about 10 bases, greater than about 100 bases, greater than about 500 bases, greater than 1000 bases, up to about 10,000 or more bases composed of nucleotides, e.g., deoxyribonucleotides or ribonucleotides, which may be produced enzymatically or synthetically, and which can hybridize with naturally occurring nucleic acids in a sequence specific manner analogous to that of two naturally occurring nucleic acids, e.g., can participate in Watson-Crick base pairing interactions. In addition to deoxyribonucleic acid (DNA) and ribonucleic acid (RNA), the term “nucleic acid” (or “polynucleotide”) may encompass peptide nucleic acid (PNA), locked nucleic acid (LNA), and unstructured nucleic acid (UNA). The term “nucleic acid” may also extend to non-natural nucleotides such as dU and rT. Additional examples include oligonucleotides (or “oligos”). The term “oligonucleotide” may refer to a biopolymer of nucleotides that may be, for example, 10 to 300 or greater nucleotides in length. Oligonucleotides may be synthetic or may be made enzymatically. Oligonucleotides may contain ribonucleotide monomers (i.e., may be oligoribonucleotides) and/or deoxyribonucleotide monomers (i.e., may be oligodeoxyribonucleotides). Oligonucleotides may include modified nucleobases. Another example is a “gene,” which may refer to a segment (e.g., 10²-10⁶ base pairs (bp)) of DNA that encodes function. Another example is a “synthon,” which may refer to a synthetic nucleic acid that has been assembled in vitro from several shorter nucleic acids (e.g., oligonucleotides) in a defined sequence or order. A synthon may include, for example, a chain assembled from 3 to 50 oligos. A synthon may be of any sequence and, in certain cases, may encode a sequence of amino acids, i.e., may be a coding sequence. In other implementations, the synthon may be a regulatory sequence such as a promoter or enhancer. In particular cases, the synthon may encode a regulatory RNA. In certain cases a synthon may have a biological or structural function.

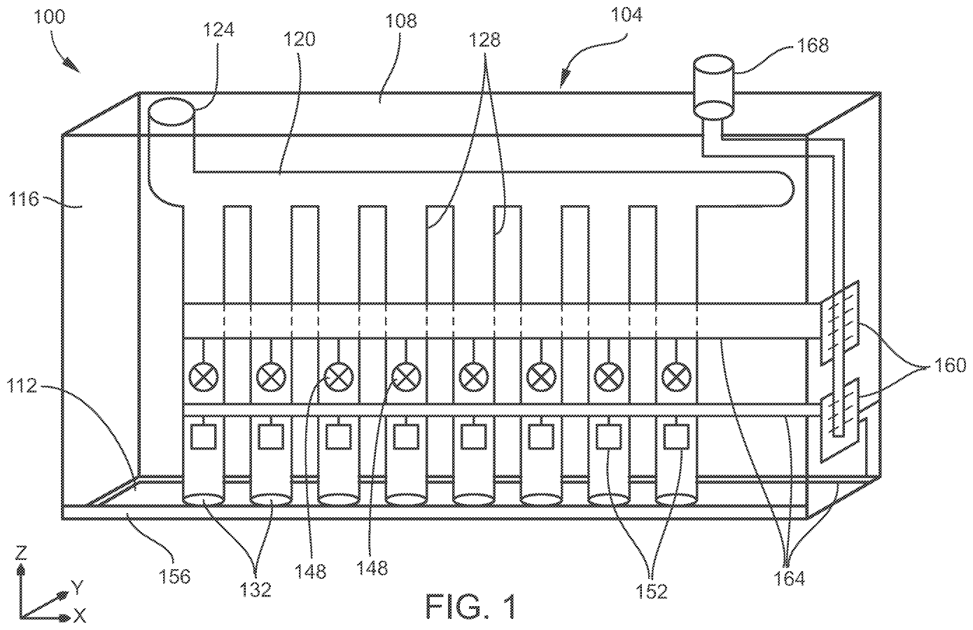

FIG. 1 is a schematic view of an example of a liquid dispensing device 100 according to an implementation. For description, FIG. 1 includes a Cartesian coordinate (X-Y-Z) frame of reference that is arbitrarily located relative to the illustration of the liquid dispensing device 100. The X-axis and the Y-axis lie in a horizontal plane, which is taken to be any ground area or other surface (e.g., bench, table, floor, etc.) on which the liquid dispensing device 100 (or the instrument of which it is a part) is supported. The Z-axis corresponds to the vertical direction. The dimensions of the X-axis, Y-axis, and Z-axis (such as relates to the liquid dispensing device 100 or any of its components) are taken to be length, depth, and height, respectively.

The liquid dispensing device 100 includes a housing 104 enclosing a device interior. The housing 104 includes a top wall 108, a bottom wall 112, and one or more side walls 116 extending from the top wall 108 to the bottom wall 112. In an implementation, the top wall 108, bottom wall 112, and side wall(s) 116 are adjoined so as to fully enclose the device interior except for openings needed to accommodate fluidic components, electrical feedthroughs, etc. The liquid dispensing device 100 also includes a manifold (or common inlet conduit) 120 disposed in the device interior. The manifold 120 includes a liquid inlet 124 disposed at the top wall 108 (as illustrated) or at one of the side walls 116. The inlet 124 may be flush with or extend through a corresponding opening in the top wall 108 (or side wall 116). The inlet 124 may include, or be engaged with, a suitable fluidic connector such as a Luer fitting, threaded fitting, or the like, to facilitate a leak-free connection with a liquid input line (e.g., tubing). The liquid dispensing device 100 further includes a plurality of (outlet) conduits (or dispense channels) 128 adjoining the manifold 120 so as to fluidly communicate with the manifold 120. The conduits 128 terminate at respective liquid outlets 132 disposed at the bottom wall 112. The outlets 132 may be flush with or extend through corresponding openings in the bottom wall 112. By this configuration, the liquid dispensing device 100 defines a plurality of liquid flow paths running from the inlet 124 through the manifold 120 (with the inlet 124 and manifold 120 defining a common liquid inlet flow path), and into and through the conduits 128 to the respective outlets 132 (with the conduits 128 and outlets 132 defining a plurality of liquid outlet flow paths branching off from the common liquid inlet flow path). In the illustrated example, the conduits 128 (or at least the outlets 132) are arranged in a one-dimensional (1D) array along the X-axis, or length, of the liquid dispensing device 100. In the present context, the term “1D array” refers to a single row (or column) of conduits 128 (and corresponding outlets 132). A 1D array may follow a straight line along the X-axis, or may follow a curved line in a net direction along the X-axis. Alternatively, the conduits 128 may be arranged in a two-dimensional (2D) array along the X- and Y-axes. In other words, the conduits 128 may be arranged in one or more columns and one or more rows.

In a typical implementation, the housing 104, manifold 120, and conduits 128 may be fabricated from an injection molded plastic (e.g., an organic polymer or polymer blend). As an example, the housing 104 may be initially provided as two halves that are adjoined (e.g., welded, glued, etc.) after incorporating the manifold 120, conduits 128, and any other internal components. More generally, the foregoing components may be fabricated from plastic, metal, glass, or ceramic materials. Depending on its composition, the material defining the inlet 124, conduits 128, and outlets 132 may be inherently chemically inert relative to the liquids flowing through these components. Here, depending on the application of the liquid dispensing device 100, the term “chemically inert” may encompass the term “biocompatible” (or “bioinert”). Alternatively, the inlet 124, conduits 128, and outlets 132 (or at least their inside surfaces) may be (bio)chemically deactivated as part of the fabrication process, such as by applying a suitable coating (or film) or surface treatment/functionalization so as to render the conduit chemically inert and/or of low absorptivity to the material. Coatings and surface treatments/functionalizations for such purposes are readily appreciated by persons skilled in the art. For example, a “biocompatible” material, coating, or surface treatment/functionalization may be effective for inhibiting or preventing the migration of neutral molecules and/or ions from the inside surface of the inlet 124, conduits 128, and outlets 132 into the liquid flowing therethrough, as appreciated by persons skilled in the art. Examples of chemically inert and/or biocompatible coatings may include, but are not limited to, members of the Parylene family (e.g., Parylene C), polyimide (PI), polyetherimide (PEI), members of the polyaryletherketone (PAEK) family (e.g., polyetherketone (PEK), polyetheretherketone (PEEK), polyetherketoneketone (PEKK), polyetheretherketoneketone (PEEKK), and polyetherketoneetherketoneketone (PEKEKK), and polymer blends containing one or more of the foregoing), etc.

In a typical (but non-exclusive) implementation and as illustrated, the manifold 120 is horizontally oriented and the conduits 128 (or at least the outlets 132) are vertically oriented and parallel to each other. In other implementations, the manifold and/or (all or part of) the conduits 128 (and/or outlets 132) may be oriented at an angle relative to both the horizontal and vertical directions. Additionally, the conduits 128 (or at least the outlets 132) are horizontally spaced from each other (e.g., along the X-axis, or a curved line in the net direction of the X-axis) at uniform distances. In an implementation, the spacing between the conduits 128 and/or outlets 132 (e.g., the horizontal distance between the central axes of the conduits 128 and/or outlets 132) is the same as the horizontal distance or pitch between the wells of a multi-well plate (or other type of containers) that are to receive liquid dispense volumes (volumes of liquid dispensed from the outlets 132). In other implementations, one or more of the conduits 128 (or at least the outlets 132) may be non-uniformly spaced from adjacent conduits 128 (or outlets 132). In one example, the distance between the conduits 128 and/or outlets 132 is in a range from 2 mm to 25 mm.

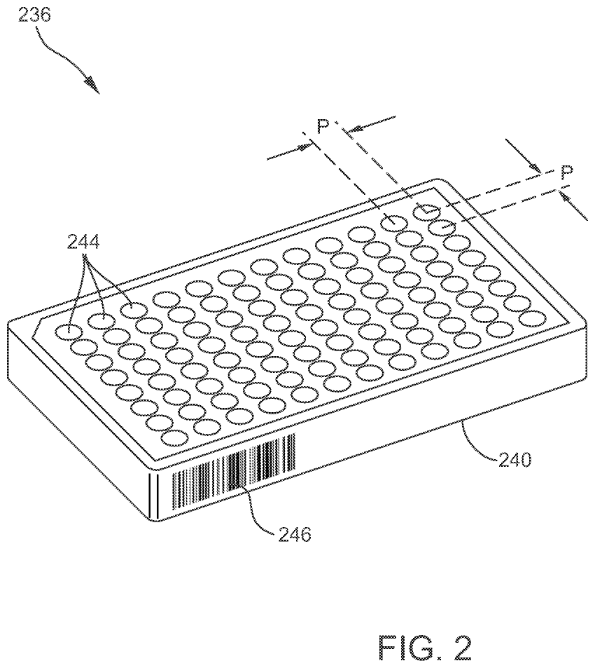

FIG. 2 is a perspective view of an example of a multi-well plate 236. The multi-well plate 236 includes a support structure 240 and a two-dimensional (2D) array (i.e., rows and columns) of wells 244, which are often integrally formed with the support structure 240. The multi-well plate 236 may also include a barcode 246 to facilitate identification and tracking of the multi-well plate 236. The 2D array may be a 2:3 rectangular array, such as the 96-well array (8 rows and 12 columns) shown in FIG. 2. The 2D array may have a greater number of wells (e.g., 384, 1536, etc.) or a lesser number of wells (e.g., 24, 54, etc.) than shown in FIG. 2. As another alternative, the 2D array may be a square array, such as a 4×4 array of 16 wells or an 8×8 array of 64 wells. In an implementation, the multi-well plate 236 has a uniform pitch P between adjacent wells 244 in each row and in each column of the array. For example, the pitch P may be taken to be the distance between the centers of two adjacent wells 244 (i.e., the center-to-distance). In an implementation, the format of the multi-well plate 236, including the dimensions and the shape of the wells 244, is a standard format in accordance with known standards such as the American National Standards Institute/Society for Laboratory Automation and Screening (ANSI/SLAS) standards for multi-well plates current at the time of filing the present disclosure. For example, the pitch P may be as specified by ANSI/SLAS 4-2004 (R2012): Microplates—Well Positions. Thus, the pitch P may be 9.0 mm for an array of 96 wells 244, 4.5 mm for an array of 384 wells 244, or 2.25 mm for an array of 1536 wells 244. The pitch P may be considered to be “substantially” equal to 9.0 mm, 4.5 mm, or 2.25 mm when allowing for the positional tolerances such as specified by ANSI/SLAS 4-2004 (e.g., +/−0.7 mm for 96-well and 384-well microplates, +/−0.5 mm for 1536-well microplates). As noted above, the spacing between the conduits 128 and/or outlets 132 of the liquid dispensing device 100 should closely match the pitch P of the wells 244, particularly to avoid the risk of cross-contamination between adjacent wells 244, splattering or spilling, etc.

A multi-well plate 236 is just one example of a set of liquid containers. In other implementations, the wells 244 may be another type of liquid container, and may be removable from the support structure 240. For example, the support structure 240 may be a rack, frame or the like and the wells 244 may be vials, bottles, cuvettes, or the like that are supported by the rack. These types of containers may be individually supported by the rack, and thus individually mountable to and removable from the rack. Moreover, such containers may be uniformly spaced from each other in a manner such as just described in regard to wells 244, or may be non-uniformly spaced.

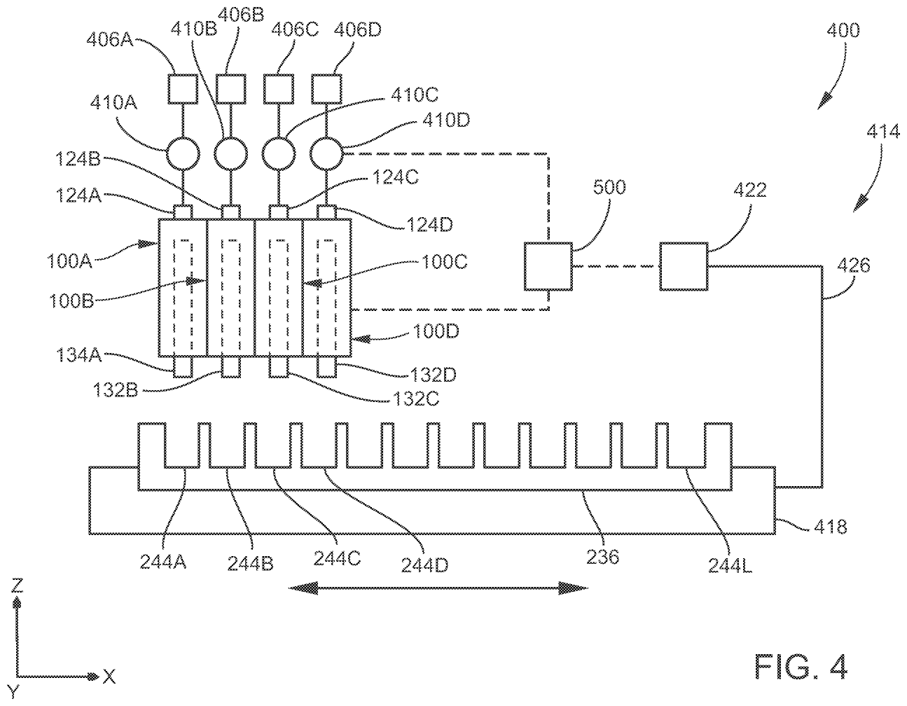

Referring back to FIG. 1, in an implementation, the housing 104 is shaped as a box with rectilinear sides (i.e., top wall 108, bottom wall 112, and side wall(s) 116). To minimize its overall footprint or form factor, the housing 104 may be sized just large enough to enclose the manifold 120, conduits 132, and any other components disposed in the device interior. The minimized size of the housing 104 may also facilitate the stacking of multiple liquid dispensing devices 100 horizontally adjacent to each other, as described below in conjunction with FIG. 4. The minimized size may also facilitate regulating the temperature (and/or other operating conditions) of the device interior if desired. For such purposes, in the illustrated example, the housing 104 is shaped as a “thin” box (e.g., like a pizza box or cereal box). In the context of this disclosure, a “thin” box means that the largest dimension of the housing 104 is its length (X-direction) to accommodate the 1D (or 2D) array of conduits 132 and outlets 132, and the smallest dimension of the housing 104 is its depth (Y-direction).

In the context of this disclosure, the term “box” or “box-shaped” encompasses “generally” box-shaped housings 104. In other words, the sides of the housing 104 are not necessarily perfectly flat or otherwise have perfect rectilinear geometry. Moreover, features (e.g., wires, connectors, bosses, etc.) may protrude from or be recessed into the outer surfaces of the sides of the housing 104. In all such cases, the housing 104 is understood to be box-shaped.

The liquid dispensing device 100 further includes a plurality of valves 148 respectively disposed in the conduits 128 for controlling the liquid flows through the conduits 128 individually. The valves 148 may be configured to control the dispense volumes (i.e., the total amounts of liquid respectively dispensed from the outlets 132 into corresponding wells 244 or other containers), which control may be based on flow time or flow rate.

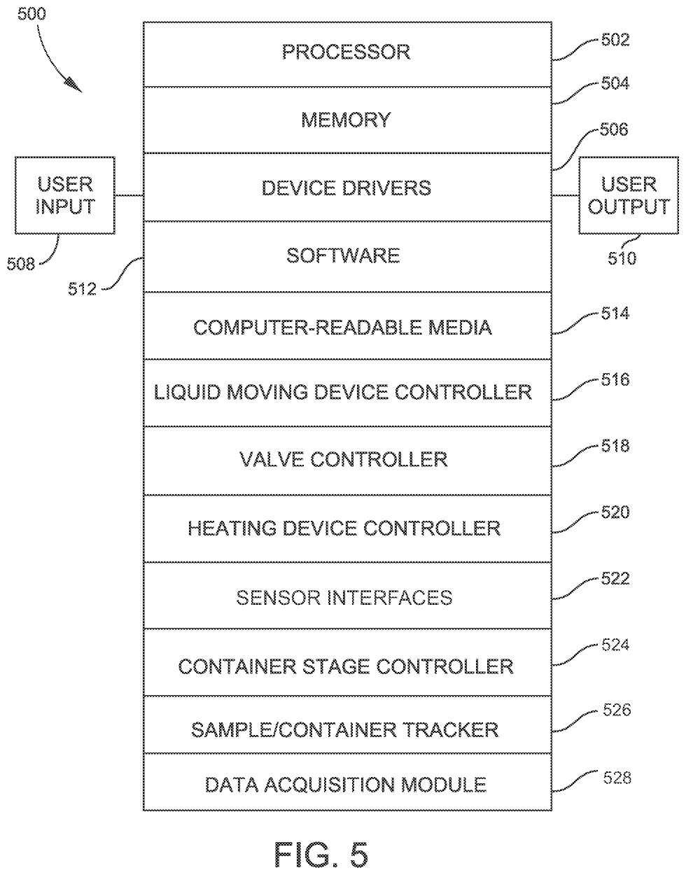

In one implementation, the valves 148 are configured for on/off operation, for example, for being switched between (fully) open and (fully) closed states. Generally, any type of on/off valve suitable for controlling liquid flow may be utilized such as, for example, solenoid valves. The valves 148 are individually controllable, i.e., individually addressable by a system controller that is part of the liquid dispensing device 100 or at least in electrical communication with the valves 148 (such as the system controller 500 described below in conjunction with FIGS. 4 and 5). Thus, the corresponding wells 244 (in a given row or column that is aligned with the outlets 132) do not all need to be filled with liquid simultaneously. Instead, the wells 244 may be filled with liquid sequentially, or only a selected subset or group of the wells 244 may be filled at a given time while the rest of the wells 244 are not filled or are filled subsequently. Moreover, the amounts of liquid dispensed into the respective wells 244 are individually controlled by implementing a pulse/time method. Namely, the flow rate of the liquid flowed into the conduits 128 (via the inlet 124 and manifold 120) is held constant, and the amounts of liquid dispensed into the respective wells 244 are individually controlled by individually controlling the period of time during which the corresponding valves 148 are “on” or open, which is referred to herein as the “valve-open duration.” In other words, the different volumes (amounts or aliquots) of liquid may be dispensed into different wells 244 by opening the corresponding valves 148 different periods of time (e.g., in a range from 10 ms to several hundreds of ms). In such implementation, the liquid flows into the conduits 128 (flow rates, start and stop times of the valve-open duration) may be controlled by a liquid moving device (not shown, but see liquid moving devices 410A-D in FIG. 4) that delivers the liquid to the inlet 124. The dispense times from the outlets 132 (such as dictated by the pulse/time method) may need to be controlled based on whether or not the wells 244 are moving relative to the outlets 132 during the dispensing step, and how the wells 244 are moved (e.g., stepwise or continuously).

Alternatively or additionally, the valves 148 may be configured to vary (adjust) liquid flow rate to values between and including the fully open and fully closed states. In this case, the flow rates through the valves 148 may be individually controlled to enable different amounts of liquid to be dispensed into different wells 244 if desired. During such dispensing operation, the period of time during which liquid flow through the conduits 128 is active may be held constant. For this purpose, in addition to the valves 148 configured for variable flow rate, one or more separate on/off valves (not separately shown) may be provided upstream of the variable flow rate valves 148, such as in the conduits 128, manifold 120, or inlet 124. As one example, a valve 148 featuring variable flow rate may be an active (i.e., controllable by a system controller) needle valve, in which the flow rate depends on the position of a needle relative to a valve seat as appreciated by persons skilled in the art. Such a needle valve may include adjustable movement stops to enable the stroke of the needle movement to be controlled/adjusted, such as by a screw, or spacers such as interchangeable spacers or a piezoelectric crystal that can be adjusted electronically to different dimensions to thereby act as a variable position stop for the needle travel. The valve 148 may also be a proportional solenoid valve controlled by an analog signal. As another example, the valve 148 may be a passive needle valve that is adjusted by screwing the valve into or out from a valve seat to change the flow rate in the corresponding conduit 128. In this latter case, the valve 148 alone may not serve to manage flow rate, but rather serve as a throttle for flow rate, and a separate valve (not separately shown) may be provided for managing the flow rate desired for the corresponding conduit 128. This latter case may also allow for calibration with a single flow rate sensor located at, for example, the inlet 124 by opening one valve 148 at a time and then adjusting the valve 148 or produce the desired flow rate in the corresponding conduit 128. A further example of a variable flow rate valve is a peristaltic valve and actuator assembly. In all such cases, the flow rate in a common inlet flow path running through the inlet 124 may be varied by an upstream liquid moving device communicating with the inlet 124 (not shown, but see liquid moving devices 410A-D in FIG. 4).

Alternatively or additionally, the flow rates through the conduits 128 may be adjusted by providing different flow restrictions or resistances in the flow paths of the individual conduits 128. As an example, the dimension(s) of the orifices of the outlets 132 may be adjusted, for example, between well filling operations. This may be done, for example, by configuring the outlets 132 to receive replaceable/exchangeable outlet components (e.g., nozzles, needles, pipette tips, etc.) having different orifice dimensions (selectable by a user), thereby allowing for substantial changes in dispense rates through the outlets 132 if desired.

The liquid dispensing device 100 may further include one or more flow rate sensors 152. For example, the liquid dispensing device 100 may include a plurality of flow rate sensors 152 respectively disposed in (or on) the conduits 128 to significantly enhance control of the liquid flow through the conduits 128 and thus the control over and accuracy of the total dispense volumes—i.e., the total volumes (amounts) of liquid respectively dispensed from the active outlets 132 (i.e., the outlets 132 being utilized during a given dispensing operation) into underlying containers. The flow rate sensors 152 may be positioned in the conduits 128 either upstream of or downstream from the valves 148 (as illustrated) as needed, and/or in the manifold 120 or inlet 124. The flow rate sensors 152 may be placed in communication with a system controller (e.g., system controller 500 shown in FIGS. 4 and 5) to provide an active feedback loop in each conduit 128 (i.e., closed-loop control). The total dispense volumes from each outlet 132 may be, for example, set or programmed by the user, or by the system controller (e.g., acting on feedback data received from the flow rate sensors 152, data retrieved from look-up tables stored in memory, and/or data or instructions received from software). Examples of the type of flow rate sensor 152 utilized include, but are not limited to, ultrasonic-based sensors, thermal-based sensors, and capacitive sensors.

Feedback measurements from the flow rate sensors 152 may be utilized to make one or more types of adjustments to operating parameters of the liquid dispensing device 100 relating to liquid flow, depending on whether dispense volumes are dictated by the valve-open durations in the case of constant flow rate, or by flow rate in the case of variable flow-rate valves 148 or a variable flow-rate liquid flow device upstream of the valves 148. The flow-rate sensor feedback may be utilized to make adjustments in real time (on the fly) during a given dispensing operation. For example, the flow rate sensors 152 may be useful for determining whether the flow rate in each conduit 128 is correct (e.g., whether the flow rate is deviating from a preset (setpoint) or otherwise expected value or beyond an acceptable tolerance range for the flow rate value). For any conduit 128, if it is determined that the actual (measured) flow rate is incorrect, an appropriate adjustment (e.g., to the valve-open duration or the flow rate itself) may be made as needed to ensure the prescribed dispense volume from each conduit 128 (or at least its outlet 132) is achieved.

Similarly, assuming that the flow rates in all active conduits 128 are intended to be the same (e.g., according to a preset flow rate), the flow rates in the respective conduits 128 may be compared to determine whether the flow rate in one or more of the conduits 128 differs from the flow rate in the other conduits 128 and/or differs from the expected or (pre)set flowrate. If needed, an adjustment to the flow rate in one or more of the conduits 128 may then be made to ensure that conduit 128 (or those conduits 128) dispense(s) the correct volume(s) of liquid.

The flow-rate sensor feedback may also be utilized to make adjustments in the nature of corrections, compensations, or calibrations that improve the accuracy of subsequent dispensing operations. For example, adjustments based on measured flow rate data may be made during or after a test run in preparation of an actual dispense operation, or during or after a given dispense operation in preparation of the next dispense operation (e.g., to correct or compensate for inaccuracies determined in one or more of the conduits 128 (or outlets 132)). As an example of a condition for which correction may be desired, the flow rate through a given conduit 128 may vary based on the number of other conduits 128 active (i.e., the number of valves 148 in the other conduits 128 that are open) based on different back pressures seen by the conduits 128 or other factors, and the magnitude of the variance may depend on which conduit 128 is being evaluated for this condition. Moreover, the flow rate may vary among individual conduits 128 (or at least their outlets 132) for a reason other than how many conduits 128, or which conduits 128, are active at the same time.

The flow rate sensors 152 may also be useful for verifying that valve actuation is working properly, such as by detecting a malfunctioning (e.g., stuck or leaky) valve 148, or for detecting a clogged conduit 128 or outlet 132.

The feedback from the flow rate sensors 152 may also be utilized in test runs of the liquid dispensing device 100 to determine whether the raw flow rate measurement data being outputted from the flow rate sensors are accurate or inaccurate (due to any number of factors associated with a flow rate sensor 152 itself, such as noise, drift, structural wear, fouling, etc.). If the raw flow rate measurement data is determined to be inaccurate, a correction may be made to the raw data (e.g., a calculated offset value, scaling factor, etc.) by the system controller.

In some implementations, the liquid containers receiving the dispense volumes from the outlets 132 (e.g., the wells of a multi-well plate such as described above with reference to FIG. 2) are movable relative to the liquid dispensing device 100 and thus relative to the outlets 132 (see, e.g., the description below relating to FIG. 4). As one example, the liquid containers may move in a stepwise (indexed) manner (e.g., move, receive dispense volume(s) in column(s) or row(s), move, receive additional dispense volume(s) in next column(s) or row(s), . . . ). In this case, the timing of the iterative movements of the liquid containers may be coordinated or synchronized with the timing of the dispensing (e.g., as may be controlled by the valves 148, which control may be assisted by feedback from the flow rate sensors 152), and valve/flow rate control (e.g., adjustment, calibration, etc.) may be executed as described above and elsewhere herein. As another example, the liquid containers may move in a continuous manner. In this case, the dispense times may be coordinated or synchronized with the position of the liquid containers relative to the outlets 132. For example, the operation of the valves 148 (e.g., the start and stop times of the valve-open conditions, or on/off states of the valves 148, as may be assisted by feedback from the flow rate sensors 152) may be controlled to adjust the flow rates among the outlets 132 as needed to ensure that the dispense times occur only within the window of time during which the outlets 132 are aligned with the liquid containers, thereby ensuring correct total dispense volumes in the respective liquid containers and avoiding spillage or splattering of the dispensed liquids.

In another implementation, a single flow rate sensor 152 may be positioned upstream of the conduits 128, such as at the inlet 124 or manifold 120, to measure the flow rate of the common inlet flow. With such configuration, the flow rate in a single conduit 128 may be measured while the other conduits 128 (or a subset of the other conduits 128) are closed (deactivated). This flow rate measurement may be performed for each conduit 128 provided.

The liquid dispensing device 100 may further include a temperature control device 156 configured to heat and/or cool the liquids in the conduits 128. As with other active components of the liquid dispensing device 100, the temperature control device 156 may be in electrical communication with, and thereby controllable by, a system controller. In one implementation, the temperature control device 156 is or includes a heating device. The heating device may include one or more heating elements disposed in the device interior that are configured (e.g., sized, shaped, positioned) to transfer heat energy to the liquids in the conduits 128 by heat conduction and/or heat convection. As examples, the heating element(s) may be mounted to the inside surface(s) of one or more of the top wall 108, bottom wall 112, and side wall(s) 116. Alternatively, individual heating elements may be mounted directly on the outside surfaces of the conduits 128. In the illustrated example, a strip-shaped heating element is positioned along the length (X-axis) of the inside surface of at least one of the side walls 116 such that heat energy is (substantially) uniformly transferred to each conduit 128. Also in the illustrated example, the heating element is positioned proximate to the outlets 132, which enhances the ability to regulate liquid temperature at the points of dispensing. Such configuration may be advantageous, for example, to ensure that concentrated solutions do not crystallize, thereby preventing undesirable clogging of the outlets 132, and/or to control the viscosity of the liquids, etc. Generally, any type of heating element may be utilized as appreciated by persons skilled in the art. As a non-exclusive example, the heating element may be an electrically resistive (Joule or ohmic) heating element.

Additionally or alternatively, the temperature control device 156 is or includes a cooling device configured to cool the liquids in the conduits 128. One non-exclusive example of a cooling device is a thermoelectric cooling device such as a Peltier cooling device.

The temperature control device 156 may further include one or more temperature sensors configured to measure the temperature of the liquids in the conduits 128. In FIG. 1, the temperature control device 156 is taken to schematically represent such temperature sensors as well as the heating and/or cooling elements. The temperature sensor(s) may also be placed in communication with a system controller to provide closed-loop control of the heating and/or cooling element(s). In this way, liquid temperature may be maintained within a desired range, which may be a narrow range, and which is adjustable for different dispensing operations and depending on the composition of the liquid being dispensed. Generally, any type of temperature sensor may be utilized as appreciated by persons skilled in the art. Examples of a temperature sensor include, but are not limited to, a resistance temperature detector (RTD), a thermistor, and an infrared (IR) based sensor.

The liquid dispensing device 100 may further include one or more locally positioned electronics-based control circuit modules 160 that communicate with the active (electronically controlled) components provided with the liquid dispensing device 100 (e.g., the valves 148, flow rate sensors 152, temperature control device 156) via suitable communication links 164, in particular to provide closed-loop control of the individual liquid channels as described herein. The control circuit modules 160 may be locally positioned in the sense that they are disposed at the liquid dispensing device 100, such as on or in the housing 104. The control circuit modules 160 may include any combination of hardware or firmware components (e.g., microelectronic chips, integrated circuits (ICs), and solid state circuit components (e.g., resistors, capacitors, inductors, etc.), mounted on rigid circuit boards or flexible circuit substrates) suitable for implementing control and monitoring of the active components, as appreciated by persons skilled in the art. The control circuit modules 160 may be configured to implement all of the system control functions needed for operating the liquid dispensing device 100, and/or may communicate with a more remotely positioned system controller that is part of a larger system or apparatus that includes the liquid dispensing device 100. The communication links 164 may be rigid or flexible electrical circuits, with wiring configured as busses, ribbons, cables, or the like. Alternatively, one or more of the communication links 164 may be wireless (e.g., links that involve the transmission (sending and/or receiving) of radio frequency (RF) signals propagating through the air). Generally, any electrical interconnection technology may be employed. One or more electrical connectors or feedthroughs 168 may be mounted at one or more corresponding openings of the housing 104 (e.g., the top wall 108 as illustrated, or a side wall 116) to provide communication (e.g., power supply, data transfer, control signal transmission, etc.) with the electrical components disposed in the device interior. Alternatively or additionally, the control circuit modules 160 may be or include RF transceiver components that serve as a wireless interface for sending and/or receiving signals to and/or from a remote server or network.

As evident from the present description, a primary function of the liquid dispensing device 100 is to take a single liquid input flow and distribute the input flow to a plurality of separate liquid channels (embodied as unique liquid output circuits, or conduits 128), in which the conditions of the respective output flows can be uniquely controlled (e.g., as to on/off states, volumes dispensed, flow rates, temperature, etc.). Compared to previously known devices such as inkjet printer-type heads and pipettor heads, the liquid dispensing device 100 may be suitable for dispensing a wide range of disparate liquids at substantially greater volumes and with much less sensitivity to varying conditions such as viscosities. The mechanical layout of the liquid dispensing device 100 allows for integration into a larger (typically automated) system or apparatus that would typically be utilized as a filling device for well plates or other containers. The liquid dispensing device 100 may be capable of performing, alone or in cooperation with a larger system of which it is a part, a wide range of tasks, from simple addition of individual liquids into wells to more complex procedures involving, for example, mixing, dilution, buffering, solvating, emulsifying, precipitating, gelling, other types of liquid conditioning, (bio)chemical reaction, (bio)chemical synthesis or assembly, lysing, chemical or enzymatic cleaving, hybridization, denaturing, labeling (e.g., with a dye, fluorophore, etc.), distilling, fractionating, filtering, analytical separation and/or collection of sample components, purification, detection/measurement of analytes, etc. Another use is to prepare well plates for cell culture with varying amounts of materials per designed experiment.

One specific application for the liquid dispensing device 100 is microscale DNA/RNA synthesis. In current state-of-the-art synthesis tools, the mechanical complexity and opportunity for leaks is significant and substantial. The liquid dispensing device 100 may be utilized in DNA/RNA synthesis-related oligonucleotide production, but at a scale where large enough amounts of DNA/RNA can be synthesized to directly provide for applications such as, for example, CRISPR/CAS9 (Clustered Regularly Interspaced Short Palindromic Repeats/CRISPR Associated Protein 9) gene editing.

In various implementations, the liquid dispensing device 100, containing a 1D or 2D array of conduits 128 and corresponding outlets 132, may operate in cooperation with a movable multi-well plate or other type of array of containers (e.g., movable past the underside of the liquid dispensing device 100) to deliver (potentially unique) volumes of liquid into the wells of one or more selected columns of the multi-well plate (e.g., up to twelve eight-well columns of the multi-well plate 236 shown in FIG. 2; see also FIG. 4). In some implementations, a group of liquid dispensing devices 100 such as the one shown in FIG. 1 may be stacked together (e.g., horizontally or side-by-side) to provide a greater number of liquid dispensing points from which liquid volumes may be delivered simultaneously or sequentially (in terms of single wells or predefined groups of wells) as needed, and with each liquid dispensing device 100 (or one or more of the liquid dispensing devices 100) supplying a different liquid as needed. In this way, a wide variety of procedures may be implemented, such as by adding two or more different liquids from two or more respective liquid dispensing devices 100 to the same well or other container (e.g., dispensing a sample solution from one liquid dispensing device 100, and then adding, from another liquid dispensing device 100, a reagent to the sample solution in the same well or other container). Such a group or stack of liquid dispensing devices 100 also may operate in cooperation with a movable multi-well plate or other type of array of containers. As to each liquid dispensing device 100, the delivery of a single type of liquid and the physical spacing between the liquid dispensing points prevent cross-contamination between the liquid channels of that liquid dispensing device 100.

In some implementations, the liquid dispensing device 100 (or stack of liquid dispensing devices 100) remains stationary while the multi-well plate (or other type of array of containers) is movable relative to the liquid dispensing device 100. By eliminating the components required for driving and controlling movement of the liquid dispensing device 100 itself, the liquid dispensing device 100 is less complex and more reliable than known approaches such as robotically movable inkjet printing heads and pipettor heads. Moreover, plate filling productivity may be exceptionally fast compared to the known approaches such as pipetting fluids from one container to another. By eliminating the pipette tip filling and moving processes, plate filling productivity can be far higher for lab automation tools. Further, the need for frequently replacing pipette tips is eliminated, thereby reducing waste.

As examples, the inside diameter of the conduits 128 is in a range from 500 μm to 5000 μm. The inside diameter of the outlets 132 may be (substantially) the same as, or smaller than, the inside diameter of the conduits 128. The flow rate through the conduits 128 may be in a range from 5 mL/min to 500 mL/min. The volume of liquid dispensed by each conduit 128 (during one iteration) may be in a range from 10 μL to 1000 μL. More generally, the volume of liquid dispensed is only practically limited by the volume (size) of the wells 244 or other containers being utilized.

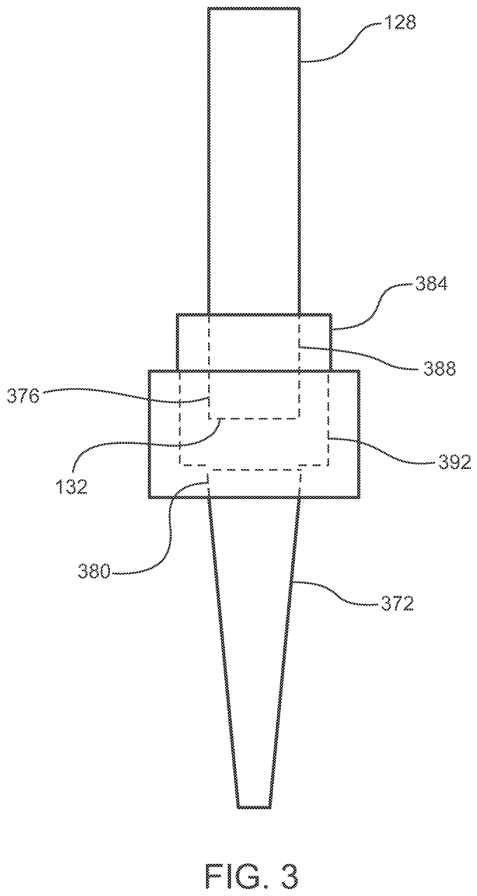

FIG. 3 is a schematic view of an example of one of the conduits 128 (or a lower end portion of the conduit 128) and a liquid output component 372 according to an implementation. The liquid output component 372 is attached to the conduit 128 at the outlet 132. For this purpose, the outlet 132 may include an engagement section 376 that serves as a fitting or adapter, i.e., is configured to attach to or mate with a complementary engagement section 380 of the output component 372. Alternatively and as illustrated, a separate fitting or adapter 384 may be provided to fluidly interconnect the outlet 132 and the output component 372. In this case, the fitting 384 may include an engagement section 388 configured to attach to or mate with a complementary engagement section 376 of the outlet 132, and another engagement section 392 configured to attach to or mate with a complementary engagement section 380 of the output component 372. The engagement sections 376, 380, 388, 392 may have any configuration suitable for making robust fluidic couplings, for example, screw-type threads, Luer-type fittings, etc. The type of output component 372 coupled to the outlet 132 of the conduit 108 depends on the implementation. Examples of the output component 372 include, but are not limited to, a pipette tip, a needle (possibly configured for piercing a septum), a nozzle, or a component having an orifice of a different size (e.g., inside diameter) than the outlet 132. The provision of a fitting or adapter, whether integral with or attached to the outlet 132, enables different types and/or different sizes of output components 372 to be utilized with each conduit 128, thereby adding flexibility in the use of the liquid dispensing device 100. As examples, different output components 372 may be utilized to provide different flow rates at the dispensing points, or to adapt to different sizes and/or different types of wells or other containers.

FIG. 4 is a schematic view of a liquid dispensing system 400 according to some implementations. The liquid dispensing system 400 includes one or more liquid dispensing devices, each of which may be configured as disclosed herein, such as the liquid dispensing device 100 described above and illustrated in FIG. 1 (or additionally FIG. 3). By example, FIG. 4 shows four liquid dispensing devices 100A, 100B, 100C, and 100D, but less or more than four may be provided. Each liquid dispensing device 100A-D includes a respective liquid inlet 124A-D, a set of (e.g., eight, see FIG. 1) liquid outlets 132A-D, and other components described above in conjunction with FIG. 1 (or additionally FIG. 3). The liquid dispensing system 400 may also include one or more multi-well plates 236 such as described above in conjunction with FIG. 2, or other type of container support(s) supporting liquid containers. Thus, in the illustrated example, the multi-well plate 236 has a 2D array of wells 244A, 244B, 244C, 244D, . . . , and 244L. Specifically in FIG. 4, twelve columns of wells (244A, 244B, 244C, 244D, . . . , and 244L) are spaced along the X-axis and eight rows of wells are spaced along the Y-axis (orthogonal to the plane of the drawing sheet). The liquid dispensing system 400 may include an optical reader (not shown) for reading any barcode 246 (FIG. 2) provided on the multi-well plate 236.

In an implementation and as illustrated, the liquid dispensing devices 100A-D are horizontally stacked or arranged in a linear (1D) array, resulting in the outlets 132A-D being arranged in a 2D array. In an implementation, the liquid dispensing devices 100A-D are stacked in a closely packed configuration. In this way, in addition to the set of outlets 132A-D of each liquid dispensing device 100A-D being (optionally) uniformly spaced from each other in a horizontal direction (e.g., the Y-axis in FIG. 4), each set of outlets 132A-D of each liquid dispensing device 100A-D may also be uniformly spaced from the correspondingly adjacent outlets 132A-D of the liquid dispensing device(s) 100A-D adjacent to that liquid dispensing device 100A-D (in the direction of the X-axis in FIG. 4). Moreover, the horizontal spacing between adjacent outlets 132A-D along both horizontal directions (X-axis and Y-axis) may be (substantially) equal to the pitch P of the 2D array of wells 244A-L of the multi-well plate 236, as described above in conjunction with FIG. 2. This configuration facilitates aligning selected sets of outlets 132A-D (i.e., the outlets 132A-D of selected liquid dispensing devices 100A-D) with selected groups of wells 244A-L. The liquid dispensing system 400 may include a fixture (e.g., frame, receptacle, etc.; not specifically shown) to which the liquid dispensing devices 100A-D are mounted. The fixture may be configured to organize the liquid dispensing devices 100A-D into the linear array such that the outlets 132A-D are aligned in the direction of well plate travel. For this purpose, the housing 104 (FIG. 1) of each liquid dispensing device 100A-D may provide a consistent spacing between the outlets 132A-D and at least one side of the housing 104.

In a further implementation, the liquid dispensing system 400 may include twelve liquid dispensing devices 100 such that all wells 244A-L of the 2D array may be simultaneously aligned with the corresponding outlets 132 of the twelve liquid dispensing devices 100. More generally, the number of liquid dispensing devices 100 provided may match the number of rows or columns of the array of containers provided. Moreover, as noted previously, each liquid dispensing device 100A-D may itself include a 2D array of outlets 132, in which case it is possible that only a single liquid dispensing device 100A-D, or just a few liquid dispensing devices 100A-D, are needed to supply liquid to the wells 244A-L during a given operation.

The liquid dispensing system 400 further includes one or more liquid reservoirs (e.g., bottles, vials, bags, etc.) and one or more liquid moving devices fluidly communicating with the liquid inlets 124A-D via appropriate liquid lines (e.g., conduits, tubing, etc.). In the present example, the liquid dispensing system 400 includes four liquid reservoirs 406A-D and four liquid moving devices (or liquid flow devices) 410A-D configured to flow liquids from the corresponding liquid reservoirs 406A-D to the corresponding liquid inlets 124A-D. Less or more than four liquid reservoirs 406A-D and four liquid moving devices 410A-D may be provided.

Depending on the implementation or application, the different liquid reservoirs 406A-D may include the same liquids or different liquids. For example, one liquid reservoir 406A-D may supply a solution containing a sample to be measured or analyzed, while another liquid reservoir 406A-D may supply a different sample solution, or a reagent (e.g., for reacting with, de-protecting, cleaving, hybridizing, denaturing, or synthesizing (bio)chemical compounds), buffer, diluent, solvent, emulsifier, label, or other type of additive, or two different reagents, cell culture fluids, etc.

Generally, the liquid moving devices 410A-D may be any devices configured for establishing a flow of liquid from the reservoirs 406A-D to the respective inlets 124A-D, i.e., to generate a force effective for delivering the liquids through appropriate liquid lines. In FIG. 4, the liquid moving devices 410A-D are depicted as being separate from the reservoirs 406A-D, but depending on the implementation, the liquid moving devices 410A-D may be located at or integrated with the reservoirs 406A-D. Moreover, depending on the implementation, the liquid moving devices 410A-D may be positioned upstream of rather than downstream from the reservoirs 406A-D. Further, the liquid moving devices 410A-D and/or the reservoirs 406A-D may be positioned in the device interiors of the respective liquid dispensing devices 100A-D. As one example, the liquid moving devices 410A-D may be separate pumps (or pumping units), or separate liquid channels of a single pump. Various types of pumps may be utilized, such as reciprocating pumps (e.g., syringe or piston pumps), impeller pumps, peristaltic pumps, etc. The liquid moving devices 410A-D may be configured to provide a variable liquid flow rate or fluid pressure that is settable/adjustable by the user, system controller, or software. Additionally or alternatively, the liquid moving devices 410A-D may be configured to provide a constant liquid flow rate or fluid pressure that is selectively modified by flow regulating devices external or internal to the liquid dispensing devices 100A-D. As another example, the liquid moving devices 410A-D may be configured as controllable pressure sources (with or without moving pumping elements) that apply fluid pressure (e.g., utilizing a suitable gas such as air, helium, nitrogen, argon, etc.) to the reservoirs 406A-D (e.g., to movable boundaries such a diaphragms) or to the liquid lines connecting the reservoirs 406A-D to the internal flow paths of the liquid dispensing devices 100A-D. In this case, the internal pressures of the reservoirs 406A-D may be individually controlled to manage flow rates, for example, to ensure consistent dispense times across different liquid dispensing devices 100A-D. In a similar example, the reservoirs 406A-D may be configured to move liquid in response to the liquid moving devices 410A-D, as pressure sources, generating a gas overpressure in the reservoirs 406A-D. As another example, the liquid moving devices 410A-D may be realized by an arrangement of the reservoirs 406A-D and associated liquid outlet lines communicating with the inlets 124A-D of the liquid dispensing devices 100A-D that enables gravity to serve as the motivating force for delivering the liquids, like in the manner of an IV bag.

The liquid dispensing system 400 further includes a hardware transport system (or subsystem) configured to move one or more components of the liquid dispensing system 400 relative to other components (which themselves may be movable or stationary). In the present example, the hardware transport system is or includes a container (e.g., plate) transport system (or subsystem) 414 configured to move one or more multi-well plates 236 (or other types of liquid containers) relative to the liquid dispensing device(s) 100A-D. In FIG. 4, the container transport system 414 is depicted by a movable stage 418 mechanically coupled to a driver or robot 422 through a transmission linkage 426 (e.g., belt and pulley, chain and cog, screw and worm gear, etc.). The stage 418 is configured to securely support one or more multi-well plates 236 during movement. The stage 418 may be configured as a conveyor that is driven to move the multi-well plate(s) 236 along the X-axis in a stepwise or continuous manner (i.e., like an assembly line configuration). More generally, the stage 418 may represent one or more stages/carriages movable along one or more axes (e.g., X-axis, Y-axis, and Z-axis) as needed to move the multi-well plate 236 to and from the liquid dispensing device(s) 100A-D, including into proper fluid alignment with selected outlets 132A-132D of the liquid dispensing device(s) 100A-D. In the present context, the term “fluid alignment” refers to a position of a given well 244A-L relative to a corresponding outlet 132A-132D (or vice versa) at which a desired volume of liquid can be successfully dispensed from the outlet 132A-132D into that well 244A-L without any loss (or without any appreciable loss) of the liquid being dispensed (e.g., due to spilling or splattering). Thus, in a typical example, a given well 244A-L is fluidly aligned with a corresponding outlet 132A-132D when that well 244A-L is located directly underneath (and usually in close proximity to) that outlet 132A-132D.

The stage 418, robot 422, and transmission linkage 426 schematically represent any combination of components useful for moving the multi-well plates 236 (or other type of container support) along a desired number of different axes (in a desired number of different directions) in an automated (robotic) manner, as for example may be typically provided in lab automation tools as appreciated by persons skilled in the art. Thus, for example, the stage 418 may translate, for example as a carriage, along an axis on a linear guide, which may be supported on another stage (or carriage) that translates along another axis on another linear guide, which in turn may be supported on yet another stage (or carriage) that translates along yet another axis on yet another linear guide. The robot 442 includes one or more motors (e.g., precision, bi-directional stepper motors) that drive the movement of the stage(s) 418, local motion control circuitry as needed, and possibly positional sensors (e.g., encoders) that track the movement or position of the stage(s) 418. The transmission linkage 426 includes the components (e.g., screws, belts, chains, etc.) that mechanically couple the motion generated by the motor(s) of the robot 442 to the motion(s) of the stage(s) 418.

In particular, as noted above, the stage 418 is movable to one or more positions at which selected wells 244A-L are in fluid alignment with the outlets 132A-132D of the liquid dispensing device(s) 100A-D. In the illustrated example, the first four columns of wells 244A-D are aligned with the 2D array of outlets 132A-132D. In some methods, two or more of the reservoirs 406A-D contain different liquids, and thus two or more of liquid dispensing device(s) 100A-D are configured to deliver the different liquids to selected wells 244A-L. In other methods, the reservoirs 406A-D contain the same liquid, and multiple liquid dispensing devices 100A-D may be utilized primarily for high-throughput filling operations.

As an example of a method or procedure, the liquid dispensing device(s) 100A-D may deliver controlled volumes of the same or different liquids (simultaneously or sequentially) to two or more of the first four columns of wells 244A-D. If the total number of outlets 132A-132D is less than the total number of wells 244A-L (e.g., if the total number of liquid dispensing device(s) 100A-D is less than the total number of wells 244A-L), this dispensing process may be repeated in coordination with translating the stage 418/multi-well plate 236. For example, in the illustrated implementation in which four liquid dispensing device(s) 100A-D are provided, the stage 418/multi-well plate 236 first may be moved to a first position at which the first four columns of wells 244A-D are fluidly aligned with the corresponding outlets 132A-132D of the liquid dispensing device(s) 100A-D. Desired volumes of liquid are then dispensed into selected wells 244A-D. Next, the stage 418/multi-well plate 236 may be moved to a second position at which the next four columns of wells (namely, 244E-H, not explicitly labeled in FIG. 4) are fluidly aligned with the corresponding outlets 132A-132D. Desired volumes of liquid are then dispensed into selected wells (244E-H). Next, the stage 418/multi-well plate 236 may be moved to a third position at which the next four columns of wells (namely, 244I-K, not explicitly labeled in FIG. 4, and 244L) are fluidly aligned with the corresponding outlets 132A-132D. Desired volumes of liquid are then dispensed into selected wells (244I-L). In this way, all of the wells 244A-L (or all selected wells of the total array of wells 244A-L) may be filled with liquid and, if desired, up to four different liquids delivered from the respective liquid dispensing device(s) 100A-D. More generally, any number of different liquids may be dispensed into the wells 244A-L, depending on the number of provided liquid dispensing device(s) 100A-D.

As another example, two or more of the liquid dispensing device(s) 100A-D may (sequentially) deliver controlled volumes of different liquids to the wells of the same column (e.g., one of the columns of wells 244A, 244B, 244C, or 244D). In this way, two or more liquids may be combined in the same well for an application-specific task (e.g., cell culturing, mixing, dilution, reaction, labeling, pH adjustment, synthesis, etc.). Such a combining operation involves moving the multi-well plate 236 (e.g., in a direction along the X-axis, as indicated by the double-headed arrow in FIG. 4) into alignment with two or more of the sets of outlets 132A-132D of the liquid dispensing device(s) 100A-D to enable the dispensing of the two or more liquids in two or more corresponding steps. For example, the stage 418 may be operated to move the first column of wells 244A into alignment with the outlets 132A of the first liquid dispensing device 100A. The first liquid dispensing device 100A may then be operated to deliver controlled volumes of a first liquid from the first reservoir 406A into the first column of wells 244A. The stage 418 may then be operated to move the first column of wells 244A into alignment with the outlets 132B of the second liquid dispensing device 100B. The second liquid dispensing device 100B may then be operated to deliver controlled volumes of a second liquid from the second reservoir 406B into the first column of wells 244A, thereby combining the first and second liquids in the wells 244A of the first column.

In all of the foregoing examples, the procedure may be repeated for the other columns of wells 244A-L in accordance with the method being implemented, by moving the multi-well plate 236 in a stepwise (indexed or start/stop) or a continuous manner as needed, in coordination with the components responsible for controlling the dispensing of liquid from the outlets 132A-132D. In all the foregoing examples, each liquid dispensing device 100A-D may be controlled or programmed to dispense different volumes of liquid (or even zero volume of liquid) from its different outlets 132A-132D into the respective wells of a given column of wells 244A, 244B, 244C, or 244D if desired, as described above in conjunction with FIG. 1.

The liquid dispensing system 400 further includes a system controller (or controller, or computing device) 500. The system controller 500 may schematically represent one or more modules (or units, or components) configured for controlling, monitoring and/or timing various functional aspects of the liquid dispensing system 400 such as, for example, the liquid input flows to and output flows from the liquid dispensing device(s) 100A-D, the temperature(s) in the liquid dispensing device(s) 100A-D, the tracking and movement of the stage 418 and the plate(s) 236 or other containers supported thereby, the preparation, conditioning, processing, measurement and/or analysis of liquids before and/or after dispensing, addressing, identification, etc. For all such purposes, the system controller 500 may be in wired or wireless communication with one or more of the components of the liquid dispensing system 400, as partially depicted in FIG. 4 by a few dashed lines, and may include any suitable combination of hardware, firmware, software, etc., including one or more electronics-based processors and memories, as appreciated by persons skilled in the art. For example, the system controller 500 may include a non-transitory (or tangible) computer-readable medium that includes non-transitory instructions for performing any of the methods disclosed herein. A further example of the system controller 500 is described below in conjunction with FIG. 5.

Depending on the implementation, the liquid dispensing system 400 may also be part of (or at least operate in conjunction with) a larger system that includes various other components as needed for proper operation, which are not specifically shown but understood by persons skilled in the art in fields such as, for example, high-throughput liquid handling and sample assaying or analysis. Examples of such other components may include, but are not limited to, a humidity control device configured to minimize the evaporation of liquids in the device interiors of the liquid dispensing device(s) 100A-D; one or more analytical instruments for analyzing liquids before or after dispensing them in a container array or plate 236 (e.g., a solid phase extraction (SPE) instrument, liquid chromatography (LC) instrument, electrophoresis instrument, mass spectrometer (MS), ion mobility spectrometer (IMS), ultraviolet/visible/infrared spectroscopy instrument, atomic emission spectroscopy (AES) or optical emission spectroscopy (OES) instrument, microscope or other measuring or imaging instrument based on visible light, fluorescence, phosphorescence, luminescence, or absorbance, etc.); a container (or plate) handling system, such as may include one or more devices for gripping/manipulating (e.g., a robotic gripper element or other end effector) the containers or plates to load them onto the stage 418 (e.g., from a storage rack, cooler, incubator, etc.) and remove them from the stage 418 (e.g., for transport to an analytical instrument, a reaction or synthesis station, etc.); positional sensors (e.g., optical encoders, relay switches, etc.) for detecting the position of a container or plate and/or its presence at a particular position; liquid sensors for detecting the presence of liquids and/or measuring liquid volumes in a well 244 or other container; optical readers for reading barcodes or other indicia that uniquely identify a container, container support, or multi-well plate 236 being utilized; etc.

FIG. 5 is a schematic view of an example of the system controller 500 according to an implementation. As noted above, the system controller 500 may schematically represent one or more modules, control units, components, or the like configured for controlling, monitoring, analyzing and/or timing the operation of various devices or components that may be provided in the liquid dispensing system 400 (or additionally a larger system of which the liquid dispensing system 400 is a part or with which the liquid dispensing system 400 operates), as well as controlling or executing one or more steps of any of the methods disclosed herein (such as, for example, steps related to flow measurement and control). In addition to those shown in FIGS. 1 and 4, such devices may include, for example, sample preparation/conditioning devices, analytical instruments, voltage sources, timing controllers, clocks, frequency/waveform generators, processors, logic circuits, memories, databases, etc. One or more modules of the system controller 500 may be, or be embodied in, for example, a computer workstation, desktop computer, laptop computer, portable computer, tablet computer, handheld computer, mobile computing device, personal digital assistant (PDA), smartphone, etc. One or more modules of the system controller 500 may communicate with one or more other modules via one or more busses or other types of communication lines or wireless links, as appreciated by persons skilled in the art.

In the illustrated implementation, the system controller 500 includes one or more electronics-based processors 502, which may be representative of a main electronic processor providing overall control, and one or more electronic processors configured for dedicated control operations or specific signal processing tasks (e.g., a graphics processing unit or GPU, a digital signal processor or DSP, an application-specific integrated circuit or ASIC, a field-programmable gate array or FPGA, etc.). The system controller 500 also includes one or more memories 504 (volatile and/or non-volatile types, e.g. RAM and/or ROM) for storing data and/or software. Stored data may be organized, for example, in one or more databases or look-up tables. The system controller 500 may also include one or more device drivers 506 for controlling one or more types of user interface devices and providing an interface between the user interface devices and components of the system controller 500 communicating with the user interface devices. Such user interface devices may include user input devices 508 (e.g., keyboard, keypad, touch screen, mouse, joystick, trackball, and the like) and user output devices 510 (e.g., display screen, printer, visual indicators or alerts, audible indicators or alerts, and the like). In various implementations, the system controller 500 may be considered as including one or more of the user input devices 508 and/or user output devices 510, or at least as communicating with them.

The system controller 500 may also include one or more types of computer programs or software 512 contained in memory and/or on one or more types of non-transitory (or tangible) computer-readable media 514. The computer-readable media 514 may also represent one or more devices of the system controller 500 configured to receive and read (and optionally write to) the computer-readable media 514. The computer programs or software 512 may contain non-transitory instructions (e.g., logic instructions) for controlling or performing various operations of the liquid dispensing system 400 (or additionally a larger system of which the liquid dispensing system 400 is a part or with which it operates), such as, for example, flow measurement and control. The computer programs or software 512 may include system software and application software. System software may include an operating system (e.g., a Microsoft Windows® operating system) for controlling and managing various functions of the system controller 500, including interaction between hardware and application software. In particular, the operating system may provide a graphical user interface (GUI) displayable via a user output device 510, and with which a user may interact with the use of a user input device 508. Application software may include software configured to control or execute various operations of the liquid dispensing system 400, and/or some or all of the steps of any of the methods disclosed herein.

The system controller 500 may also include a liquid moving device controller (or control module) 516 configured to control the operations of the liquid moving device(s) 410A-D (FIG. 4), and a valve controller (or control module) 518 configured to control the operations of the valve(s) 148 (FIG. 1) of each liquid dispensing device 100A-D (FIG. 4). The liquid moving device controller 516 and the valve controller 518 may coordinate or synchronize the operations of the liquid moving device(s) 410A-D and valve(s) 148 as needed to control the liquid flows through the common liquid input channel (inlet 124, manifold 120) and individual liquid output channels (conduits 128, outlets 132), including on/off states, flow rates, and dispensed volumes, of each liquid dispensing device 100A-D. The control provided by the liquid moving device controller 516 and/or the valve controller 518 may be based at least in part on feedback measurement signals received from the flow sensors 152 (FIG. 1). The system controller 500 may also include a temperature control device controller (or control module) 520 configured to control the operations of the temperature control device 156 (FIG. 1, if provided), in particular the heating and/or cooling element(s) thereof, which control may be based at least in part on feedback measurement signals received from one or more temperature sensors as described above. The operations of the temperature control device controller 520 may be coordinated or synchronized with the operations of the liquid moving device(s) 410A-D and/or valve(s) 148 as appropriate.

The system controller 500 may also include one or more sensor interfaces 522 configured to receive and process feedback (e.g., measurement) signals received from one or more sensors provided with the liquid dispensing device(s) 100 or liquid dispensing system 400, such as the flow sensor(s) 152, temperature sensor(s) of the temperature control device 156 (FIG. 1, if provided), etc. For example, the sensor interfaces 522 may be embodied in different pieces of firmware or other electronic circuitry that are part of a microcontroller of the system controller 500. The sensor interfaces 522 may communicate with controllers of the system controller 500 (e.g., liquid moving device controller 516, valve controller 518, temperature control device controller 520, etc.) as needed to effectively control (e.g., set, adjust, log data, etc.) various operating parameters of the liquid dispensing device(s) 100 or liquid dispensing system 400, such as total liquid volume dispensed and/or liquid flow rates, liquid temperature, etc. The firmware or other electronic circuitry embodying such controllers also may be provided with the same microcontroller that incudes the sensor interfaces 522, or may be provided with separate hardware of the system controller 500.

The system controller 500 may also include a container stage controller (or control module) 524 configured to control the operations of the container transport system 414, in particular the robot 422, and hence the movements of the container stage 418 (particularly while supporting the multi-well plate(s) 236 or other types of liquid containers), including preprogrammed itineraries to and from selected outlets 132A-D of the liquid dispensing devices 100A-D. The operations of the container stage controller 524 may be coordinated or synchronized with the operations of the liquid moving device(s) 410A-D and/or valve(s) 148 as appropriate for a given method being implemented.

The system controller 500 may also include a sample/container tracker (or tracking module) 526. The sample/container tracker 526 may be configured to, for example, keep track of (at various stages of the method being implemented) the location(s) of the container support(s) 236 (e.g., multi-well plate(s)), the addresses or positions of the individual containers (e.g., wells) 244A-L of a given container support 236, the condition of whether a given container 244A-L has been utilized (e.g., filled with liquid), identification of or information regarding the liquid(s) and other material(s) dispensed into a given container or well 244A-L, etc. The operations of the sample/container tracker 526 may be coordinated or synchronized with the operations of other modules of the system controller 500 and/or components of the liquid dispensing system 400 as needed.

As noted elsewhere herein, in some implementations, the liquid dispensing system 400 may be part of (or at least operate in conjunction with) a larger system that includes one or more analytical instruments configured to measure or detect one or more attributes or properties of, or to otherwise analyze, the liquid volumes that have been dispensed into the containers (e.g., the wells of multi-well plate(s) 236) by the liquid dispensing system 400. In such implementations, the system controller 500 may also include a data acquisition/signal conditioning module (DAQ) 528 configured for receiving and processing appropriate measurement signals outputted by the analytical instrument(s) (e.g., from appropriate detector(s) thereof). The DAQ 528 and/or other modules of the system controller 500 may also be configured for formatting the acquired data for presentation in graphical form by the GUI (e.g., chromatograms, mass spectra, electropherograms, images of samples, contoured or “heat” maps showing 3D data, etc.). The operations of the DAQ 528 may be coordinated or synchronized with the operations one or more modules of the liquid dispensing system 400 as needed. For example, the container transport system 414 may be configured to transport multi-well plate(s) 236 (or other containers) from the liquid dispensing system 400 to one or more analytical instruments.

Any of the foregoing modules 516-528 may be embodied in hardware, firmware, or software, or some combination of hardware, firmware, and/or software, as needed and as appreciated by persons skilled in the art.

It will be understood that FIGS. 4 and 5 provide high-level, schematic depictions of an example of the system controller 500 and associated components consistent with the present disclosure. Other components may be included as needed for practical implementations, which are not shown but are understood by persons skilled in the art. It will also be understood that the system controller 500 is schematically represented in FIGS. 4 and 5 as functional blocks intended to represent structures (e.g., hardware, circuitry, firmware, software, mechanisms, etc.) that may be provided. The various functional blocks and signal links have been arbitrarily located for purposes of illustration only and are not limiting in any manner. Persons skilled in the art will appreciate that, in practice, the functions of the system controller 500 may be implemented in a variety of ways and not necessarily in the exact manner illustrated in FIGS. 4 and 5 and described herein.

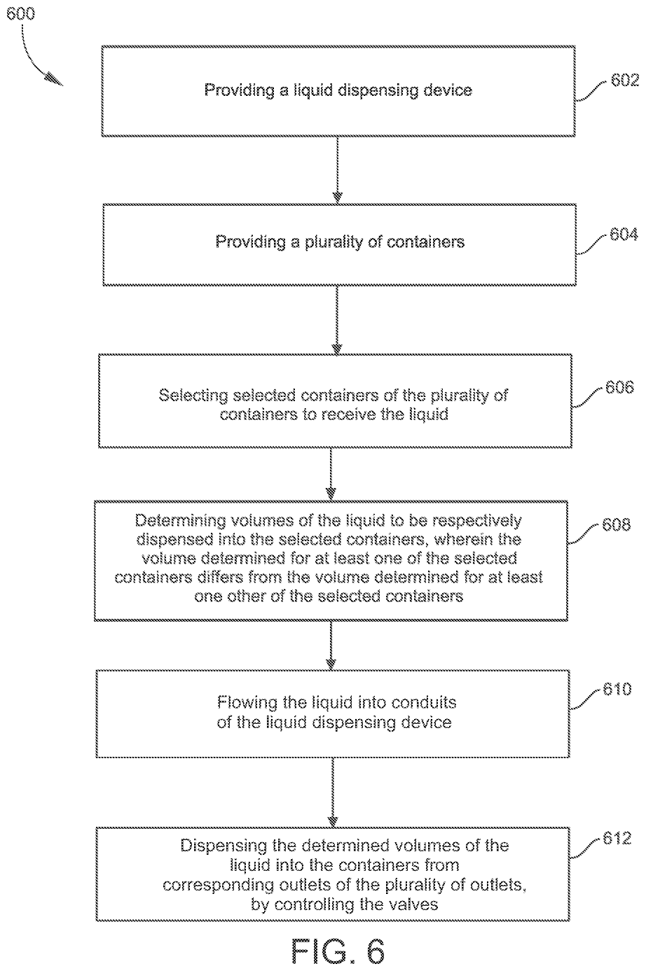

FIG. 6 is a flow diagram 600 illustrating an example of a method for dispensing a liquid according to an implementation of the present disclosure. According to the method, a liquid dispensing device as described herein is provided (step 602). Thus, the liquid dispensing device may include a manifold, a plurality of conduits, and a plurality of valves respectively disposed in the conduits, with the manifold including an inlet and the plurality of conduits including a plurality of outlets, respectively. A plurality of containers as described herein is also provided (step 604). One or more of the containers (selected containers) are selected to receive the liquid (step 606). Volumes (or amounts, aliquots, etc.) of the liquid to be respectively dispensed into the selected containers are determined (step 608). According to one aspect of the method, the volume determined for at least one of the selected containers differs from the volume determined for at least one other of the selected containers. The liquid is flowed (i.e., a flow of the liquid is established) through the inlet and the manifold, and into each of the conduits (step 610). The determined volumes of the liquid are then dispensed into the selected containers from corresponding outlets of the plurality of outlets, by controlling the valves (step 612) and possibly other components of the liquid dispensing device described herein. One or more of the steps of the method (e.g., selecting the containers, determining the volumes to be dispensed, flowing the liquid (including flow conditions such as flow rate, temperature, etc.), and dispensing the determined volumes), may be initiated or controlled by user input, or by the system controller 500 based on data received from sensors or stored in memory or based on programmed instructions provided by software, as appreciated by persons skilled in the art.

The sequence of steps 602-612 shown in FIG. 6 may be a typical example. It will be understood, however, that the sequence may be changed as to one or more of the steps 602-612, and some of the steps 602-612 may be performed simultaneously.

In an implementation, the flow diagram 600 may represent a liquid dispensing device or system, or part of a liquid dispensing device or system, configured to carry out the steps 602-612. For this purpose, a controller (e.g., the controller 500 shown in FIGS. 4 and 5) including a processor, memory, and other components as appreciated by persons skilled in the art, may be provided to control the performance of one or more of the steps 602-612, such as by controlling the components of the liquid dispensing device or system involved in carrying out one or more of the steps 602-612.

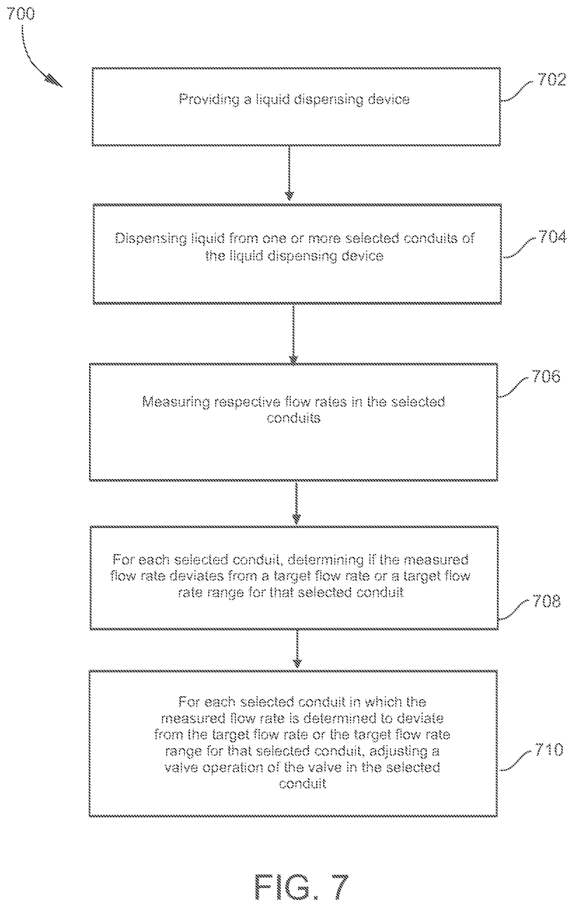

FIG. 7 is a flow diagram 700 illustrating another example of a method for dispensing a liquid according to an implementation of the present disclosure. According to the method, a liquid dispensing device as described herein is provided (step 702). Thus, the liquid dispensing device may include a manifold, a plurality of conduits, and a plurality of valves respectively disposed in the conduits, with the manifold including an inlet and the plurality of conduits including a plurality of outlets, respectively. Liquid is dispensed from one or more selected conduits of the plurality of conduits (step 704). The respective flow rates of the liquid in the selected conduits are measured (step 706). For each selected conduit, a determination is made as to whether the measured flow rate deviates from a target flow rate, or a target flow rate range, set for the selected conduit (step 708). For each selected conduit in which the measured flow rate is determined to deviate from the target flow rate or the target flow rate range for that selected conduit, a valve operation of the valve in the selected conduit is adjusted (step 710). Typically, the valve operation is one that determines the volume of liquid dispensed from the conduit/outlet associated with that valve, and thus the volume of liquid dispensed into an underlying container. Moreover, the valve operation depends on whether the valves operate according to a variable valve-open duration with constant flow rate, or the valves themselves are configured to vary flow rate. Thus, examples of such valve operations include, but are not limited to, the period of time during which the valve is open (valve-open duration), particularly in the case of constant flow rate; or in the case of a variable flow rate valve, the flow rate set by the valve.

The sequence of steps 702-710 shown in FIG. 7 may be a typical example. It will be understood, however, that the sequence may be changed as to one or more of the steps 702-710, and some of the steps 702-710 may be performed simultaneously.

In an implementation, the flow diagram 700 may represent a liquid dispensing device or system, or part of a liquid dispensing device or system, configured to carry out the steps 702-710. For this purpose, a controller (e.g., the controller 500 shown in FIGS. 4 and 5) including a processor, memory, and other components as appreciated by persons skilled in the art, may be provided to control the performance of one or more of the steps 702-710, such as by controlling the components of the liquid dispensing device or system involved in carrying out one or more of the steps 702-710.

### Example—Dispense Volume Adjustment Process

This Example is based on the case of the liquid dispensing device as described herein configured with a non-adjustable flow rate and one flow rate sensor in each dispense channel per device (e.g., as shown in FIG. 1), which defines that changing Valve-Open Duration is the only form of dispense volume adjustment. This dispense volume correction process can be utilized on an as-needed basis to correct flowrates for subsequent batch processing or can be done continuously for closed-loop operation.
1) Time data is recorded by various device components at frequencies dependent on the device, but all are referenced to established time standards. For example, one component records at 10 Hz or ten times per second and records relative to standard clock time, while another component records at 1000 Hz or one thousand times per second. Records for both are made relative to standard time (i.e.: hh:mm:ss.ms) establishing Timepoints for each component needed to compare data between components.
2) Valve State data, either Valve Open or Valve Closed, is defined for each Timepoint by the device control system (e.g., the system controller shown in FIGS. 4 and 5). The control system provides a Valve Actuation signal to each dispense valve, which opens each valve until the signal is extinguished, closing the valves. This process delivers the fluid being dispensed.
3) Valve-Open Duration Valve Open timing is controlled by the device control system per a table of Valve Flowrates that is compiled to account for differing flowrates when different numbers of nozzles (i.e, the outlets 132 shown in FIGS. 1 and 4) are utilized, as one open nozzle will flow somewhat more than the same nozzle will when all nozzles are open. Valve-Open Duration is calculated from a combination of the requested Dispense Volume and the Valve Flowrate data from the table for the specific nozzle configuration, for example based on the following relation: ((Valve Flowrate in mL/s)×(Valve-Open Duration in s))/(Dispense Volume in mL).
4) Raw Flowrate data is collected from flow rate sensors measuring the dispensed fluid and is recorded by the device control system at Timepoints for each nozzle and data records also identify device and nozzle position. Flowrate data is typically recorded without interruption and unneeded data is ignored, but data recording can be activated only when needed.
5) Dispense Samples are initiated by the control system in a predetermined pattern intended to evaluate the flowrate in a variety of dispense nozzle use configurations. Two such nozzle use configurations tested are one where only one nozzle is flowing and another where all nozzles are flowing. Additional test configurations can improve data quality and there are no restrictions on the dispense pattern used for data gathering. Examples include testing each of the nozzles individually instead of only one, testing in groups of nozzles other than one or all, etc. Once data is obtained, approximate flow rates for all nozzle use configurations can be calculated, and increased data reduces relative error of the calculated flow rate values.
6) Data Analysis Process for Dispense Volume Adjustment
a. Valve Open Duration: For any dispense cycle, the first Valve Open Timepoint is subtracted from the first Valve Closed Timepoint to produce the Valve Open Duration, the time used to deliver the specified volume of fluid, i.e.: Dispense Volume=Flow Rate×Valve Open Duration. Note that adjusting the Valve Open Duration results in actual dispense volume changes.
b. Flow Duration Determination: After selecting relevant Raw Flowrate data for the dispense cycle to be evaluated, data is compared to a predefined threshold value to determine the Flow Start and Flow Stop Timepoints. Subtracting the Flow Start from the Flow Stop Timepoint results in a Flow Duration data point. The threshold value is greater than the highest value expected in normal noise data when the valves are closed.
c. Flow Rate Zero Correction: For a subset of Flowrate data points before the dispense, Raw Flowrate data with Valve Closed is averaged to produce a Zero Offset value. Raw Flowrate data between Flow Start and Flow Stop Timepoints has the Zero Offset value subtracted, resulting in Corrected Flowrate data.
d. Flow Rate and Volume Calculation (Averaging Method): Corrected Flowrate Data between Flow Start and Flow Stop Timepoints is averaged to produce an Average Flowrate during the dispense. If needed, the Average Flowrate is multiplied by the Flow Duration time to produce a Measured Flow Volume data point. This process is repeated for all nozzle use configurations being evaluated.
e. Dispense Volume Adjustment: For each nozzle use configuration, the Average Flowrate data is compared to Flowrate Setpoint per the formula: Corrected Flowrate Setpoint=Average Flowrate×Correction Factor, where the Correction Factor=actual flowrate/measured flow rate). The Corrected Flowrate Setpoint is entered into the table of Valve Flowrates to overwrite the setpoint that produced erroneous dispense volumes.

### EXEMPLARY IMPLEMENTATIONS

Exemplary implementations provided in accordance with the presently disclosed subject matter include, but are not limited to, the following:
1. A liquid dispensing device, comprising: a housing enclosing a device interior; a manifold disposed in the device interior and comprising an inlet; a plurality of conduits disposed in the device interior and communicating with the manifold, and comprising a plurality of outlets, respectively; and a plurality of actively controllable valves respectively disposed in the conduits, the valves configured to control respective flows of liquid through the conduits, wherein the liquid dispensing device defines a common liquid input flow path in the manifold, and a plurality of liquid output flow paths running from the manifold, through the respective conduits and to the respective outlets.
2. The liquid dispensing device of implementation 1, wherein the housing is box-shaped.
3. The liquid dispensing device of implementation 1 or 2, wherein the outlets are horizontally spaced from each other at a distance selected from the group consisting of: a distance in a range from 2 mm to 25 mm; a distance of 9.0 mm; a distance of 4.5 mm; and a distance of 2.25 mm.
4. The liquid dispensing device of any of the preceding implementations, wherein the valves are configured for on/off flow control, variable flow rate control, or both on/off flow control and variable flow rate control.
5. The liquid dispensing device of any of the preceding implementations, comprising one or more flow rate sensors respectively disposed at the conduits, or the manifold, or both the conduits and the manifold.
6. The liquid dispensing device of implementation 5, comprising a controller configured to control the valves based on output signals received from the one or more flow rate sensors.
7. The liquid dispensing device of implementation 6, wherein: a valve operation of the valves determines, for each liquid output flow path, a dispense volume of liquid dispensed from the corresponding outlet; and the controller is configured to control the valve operation to control the dispense volumes of liquid respectively dispensed from the outlets.
8. The liquid dispensing device of implementation 7, wherein the valve operation comprises one of: periods of time during which the respective valves are open; flow rates set by the respective valves.
9. The liquid dispensing device of implementation 7, wherein the controller is configured to: determine if the dispensed volumes equal target volumes or target volume ranges set for the respective outlets, based on the output signals received from one or more of the flow rate sensors; andfor any dispensed volume determined to be non-equal to the target volume or outside the target volume range set for the corresponding outlet, adjust the valve operation of the corresponding valve to achieve the target volume or target volume range.
10. The liquid dispensing device of any of the preceding implementations, comprising a controller configured to control the steps of: selecting selected outlets from which to dispense the liquid; determining volumes of the liquid to be respectively dispensed from the selected outlets; flowing the liquid through the inlet and the manifold, and into the conduits; and dispensing the liquid according to the determined volumes from the corresponding selected outlets, by controlling the valves.
11. The liquid dispensing device of any of the preceding implementations, comprising a controller configured to control the steps of: selecting selected containers from a plurality of containers; determining volumes of liquid to be respectively dispensed into the selected containers; flowing the liquid through the inlet and the manifold, and into the conduits; and dispensing the liquid according to the determined volumes into the selected containers from corresponding outlets of the plurality of outlets, by controlling the valves.
12. The liquid dispensing device of any of the preceding implementations, comprising a controller configured to control the steps of: dispensing liquid from one or more selected conduits of the plurality of conduits; measuring respective flow rates of the liquid in the selected conduits; for each selected conduit, determining if the measured flow rate deviates from a target flow rate or a target flow rate range set for the selected conduit; for each selected conduit in which the measured flow rate is determined to deviate from the target flow rate the target flow rate range, adjusting a valve operation of the valve in the selected conduit.
13. The liquid dispensing device of implementation 12, wherein the valve operation comprises one of: periods of time during which the respective valves are open; flow rates set by the respective valves.
14. The liquid dispensing device of any of the preceding implementations, comprising a temperature control device configured to heat and/or cool liquid in the conduits.
15. The liquid dispensing device of implementation 14, comprising a temperature sensor communicating with the temperature control device and configured to measure temperature of the liquid in the conduits.
16. The liquid dispensing device of implementation 15, comprising a controller configured to control the temperature based on output signals received from the temperature sensor.
17. The liquid dispensing device of any of the preceding implementations, comprising a plurality of fluidic fittings respectively attached to or integral with the outlets, and configured to engage respective fluidic outlet components.
18. The liquid dispensing device of any of the preceding implementations, comprising a controller configured to control the valves.
19. The liquid dispensing device of implementation 18, wherein the controller is disposed on the housing or in the device interior.
20. The liquid dispensing device of any of the preceding implementations, comprising a reservoir communicating with the inlet, and a fluid moving device configured to flow liquid from the reservoir to the inlet.
21. The liquid dispensing device of implementation 20, wherein the fluid moving device comprises a pump.
22. The liquid dispensing device of implementation 20, wherein the fluid moving device comprises a pressure source configured to pressurize the reservoir to a controlled internal pressure.
23. The liquid dispensing device of any of implementations 1-19, comprising a reservoir and a tube fluidly interconnecting the reservoir and the inlet, wherein the reservoir and the tube are configured to flow liquid via gravity feed.
24. A liquid dispensing system, comprising a plurality of the liquid dispensing devices of any of the preceding implementations, wherein the liquid dispensing devices are horizontally stacked such that the outlets of the liquid dispensing devices are arranged in a two-dimensional array.
25. The liquid dispensing system of implementation 24, wherein, for each liquid dispensing device, at least one outlet of the liquid dispensing device is aligned with corresponding outlets of the other liquid dispensing devices along a straight line or a curved line.
26. The liquid dispensing system of implementation 24 or 25, wherein the outlets of each liquid dispensing device are horizontally spaced at a uniform distance from corresponding outlets of an adjacent one of the liquid dispensing devices.
27. The liquid dispensing system of implementation 24 or 25, wherein one or more outlets of the liquid dispensing devices are horizontally spaced at a non-uniform distance from the outlets of an adjacent one of the liquid dispensing devices.
28. The liquid dispensing system of any of implementation 24-27, comprising a plurality of liquid reservoirs respectively communicating with the inlets of the liquid dispensing devices.
29. The liquid dispensing system of implementation 28, wherein the liquid reservoirs are configured to be independently pressurized to individual internal pressures.
30. The liquid dispensing system of any of implementation 24-29, comprising a controller configured to control the steps of: selecting two or more selected liquid dispensing devices of the plurality of the liquid dispensing devices; supplying two or more liquids to the respective inlets of the selected liquid dispensing devices; and dispensing amounts of the two or more liquids from the respective outlets of the selected liquid dispensing devices into one or more containers, by controlling the valves of the selected liquid dispensing devices.
31. A liquid dispensing system, comprising: the liquid dispensing device of any of the preceding implementations; and a stage movable along one or more axes, and configured to move a plurality of containers to and from the liquid dispensing device.
32. The liquid dispensing system of implementation 31, wherein the outlets are horizontally spaced from each other at a uniform center-to-center outlet distance, and the outlet distance is equal to a pitch at which the containers are spaced from each other.
33. The liquid dispensing system of implementation 31 or 32, wherein the controller is configured to control, before the dispensing, the stage to move the plurality of containers to a dispensing position at which the selected containers are located under the corresponding outlets.
34. The liquid dispensing system of implementation 33, wherein the controller is configured to move the plurality of containers along two or more axes.
35. A method for dispensing a liquid, the method comprising: providing a liquid dispensing device comprising a manifold, a plurality of conduits, and a plurality of valves respectively disposed in the conduits, wherein the manifold comprises an inlet and the plurality of conduits comprise a plurality of outlets, respectively; providing a plurality of containers; selecting selected containers of the plurality of containers to receive the liquid; determining volumes of the liquid to be respectively dispensed into the selected containers, wherein the volume determined for at least one of the selected containers differs from the volume determined for at least one other of the selected containers; flowing the liquid through the inlet and the manifold, and into the conduits; and dispensing the liquid according to the determined volumes into the selected containers from corresponding outlets of the plurality of outlets, by controlling the valves.
36. The method of implementation 35, comprising, before the dispensing, moving the plurality of containers to a dispensing position at which the selected containers are located under the corresponding outlets.
37. The method of implementation 36, wherein the plurality of containers is arranged as a two-dimensional array, the dispensing position is a first dispensing position, and the selected containers are first selected containers of a first column of the array, and the method further comprises: after the dispensing into the first selected containers, moving the plurality of containers to a second dispensing position at which containers of a second column of the array are aligned with corresponding outlets of the plurality of outlets; and dispensing additional determined volumes of the liquid into selected containers of the second column from corresponding outlets of the plurality of outlets.
38. The method of any of implementations 35-37, wherein the containers are wells of a multi-well plate.
39. The method of any of implementations 35-38, wherein the valves are switchable between on and off states, and the dispensing comprises controlling respective periods of time during which the valves are in the on state.
40. The method of any of implementations 35-38, wherein the valves are configured for variable flow rates, and the dispensing comprises controlling respective flow rates set by the valves.
41. The method of any of implementations 35-40, comprising controlling a flow rate of the liquid by controlling an internal pressure of a liquid reservoir communicating with the inlet.
42. The method of any of implementations 35-41, wherein the dispensing comprises controlling the valves based on respective flow rates sensed in the conduits.
43. The method of any of implementations 35-42, comprising, while flowing the liquid, controlling liquid temperature in the conduits.
44. The method of implementation 43, comprising controlling the liquid temperature based on a temperature sensed in a device interior of the liquid dispensing device.
45. The method of any of implementations 35-44, wherein: the liquid dispensing device is one of a plurality of liquid dispensing devices, each comprising a manifold, a plurality of conduits, and a plurality of valves respectively disposed in the conduits, wherein each manifold comprises an inlet and the conduits of each manifold comprise respective outlets; and the liquid dispensing devices are horizontally stacked such that the outlets of the liquid dispensing devices are arranged in a two-dimensional array.
46. The method of implementation 45, comprising: selecting two or more selected liquid dispensing devices of the plurality of the liquid dispensing devices; and supplying two or more liquids to the respective inlets of the selected liquid dispensing devices, wherein: the selecting comprises selecting selected containers of the selected liquid dispensing devices to receive the liquid; the determining comprises determining volumes of the liquid to be respectively dispensed into the selected containers of the selected liquid dispensing devices; and the dispensing comprises dispensing the two or more liquids according to the determined volumes from the respective outlets of the selected liquid dispensing devices into the selected containers, by controlling the valves of the selected liquid dispensing devices.
47. The method of implementation 46, wherein at least one of the two or more liquids has a composition different from the rest of the two or more liquids.
48. The method of implementation 46 or 47, wherein the plurality of liquid dispensing devices comprises at least a first liquid dispensing device and a second liquid dispensing device, and the dispensing comprises simultaneously dispensing a first liquid from the first liquid dispensing device and a second liquid from the second liquid dispensing device.
49. The method of implementation 46 or 47, wherein the plurality of liquid dispensing devices comprises at least a first liquid dispensing device and a second liquid dispensing device, and the dispensing comprises sequentially dispensing a first liquid from the first liquid dispensing device and a second liquid from the second liquid dispensing device.
50. The method of any of implementations 46-49, wherein the plurality of liquid dispensing devices comprises at least a first liquid dispensing device and a second liquid dispensing device, the plurality of containers is arranged as a two-dimensional array, and the dispensing comprises: dispensing a first liquid from the first liquid dispensing device into one or more selected containers of a first column of the array; and dispensing a second liquid from the second liquid dispensing device into one or more selected containers of a second column of the array.
51. The method of any of implementations 46-49, wherein the plurality of liquid dispensing devices comprises at least a first liquid dispensing device and a second liquid dispensing device, the plurality of containers is arranged as a two-dimensional array, and the dispensing comprises: dispensing a first liquid from the first liquid dispensing device into one or more selected containers of a selected column of the array; and dispensing a second liquid from the second liquid dispensing device into one or more of the selected containers of the same selected column.
52. The method of implementation 51, comprising: before the dispensing of the first liquid, aligning the selected column with the outlets of the first liquid dispensing device; and before the dispensing of the second liquid, moving the plurality of containers to align the selected column with the outlets of the second liquid dispensing device.
53. The method of implementation 35, comprising one or more features of implementations 1-34.
54. A method for dispensing a liquid, the method comprising: providing a liquid dispensing device comprising a manifold, a plurality of conduits, and a plurality of valves respectively disposed in the conduits, wherein the manifold comprises an inlet and the plurality of conduits comprise a plurality of outlets, respectively; dispensing liquid from one or more selected conduits of the plurality of conduits; measuring respective flow rates of the liquid in the selected conduits; for each selected conduit, determining if the measured flow rate deviates from a target flow rate or a target flow rate range set for the selected conduit; for each selected conduit in which the measured flow rate is determined to deviate from the target flow rate or the target flow rate range for that selected conduit, adjusting a valve operation of the valve in the selected conduit.
55. The method of implementation 54, wherein the valve operation comprises one of: periods of time during which the respective valves are open; flow rates set by the respective valves.
56. The method of implementation 54, comprising one or more features of implementations 1-52.
57. A non-transitory computer-readable medium, comprising instructions stored thereon, that when executed on a processor, control or perform one or more of the steps of any of implementations 35-56.
58. A liquid dispensing system, comprising the non-transitory computer-readable storage medium of implementation 57.

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the system controller 500 schematically depicted in FIGS. 4 and 5. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the system controller 500 schematically depicted in FIGS. 4 and 5), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It will also be understood that the term “in signal communication” or “in electrical communication” as used herein means that two or more systems, devices, components, modules, or sub-modules are capable of communicating with each other via signals that travel over some type of signal path. The signals may be communication, power, data, or energy signals, which may communicate information, power, or energy from a first system, device, component, module, or sub-module to a second system, device, component, module, or sub-module along a signal path between the first and second system, device, component, module, or sub-module. The signal paths may include physical, electrical, magnetic, electromagnetic, electrochemical, optical, wired, or wireless connections. The signal paths may also include additional systems, devices, components, modules, or sub-modules between the first and second system, device, component, module, or sub-module.

More generally, terms such as “communicate” and “in . . . communication with” (for example, a first component “communicates with” or “is in communication with” a second component) are used herein to indicate a structural, functional, mechanical, electrical, signal, optical, magnetic, electromagnetic, ionic or fluidic relationship between two or more components or elements. As such, the fact that one component is said to communicate with a second component is not intended to exclude the possibility that additional components may be present between, and/or operatively associated or engaged with, the first and second components.

It will be understood that various aspects or details of the invention may be changed without departing from the scope of the invention. Furthermore, the foregoing description is for the purpose of illustration only, and not for the purpose of limitation—the invention being defined by the claims.

What is claimed is:

1. A liquid dispensing device, comprising:
a housing enclosing a device interior;
a manifold disposed in the device interior and comprising an inlet;
a plurality of conduits disposed in the device interior and communicating with the manifold, and comprising a plurality of outlets, respectively; and
a plurality of actively controllable valves respectively disposed in the conduits, the valves configured to control respective flows of liquid through the conduits,
wherein the liquid dispensing device defines a common liquid input flow path in the manifold, and a plurality of liquid output flow paths running from the manifold, through the respective conduits and to the respective outlets.

2. The liquid dispensing device of claim 1, comprising one or more flow rate sensors respectively disposed at the conduits, or the manifold, or both the conduits and the manifold.

3. The liquid dispensing device of claim 2, comprising a controller configured to control the valves based on output signals received from the one or more flow rate sensors.

4. The liquid dispensing device of claim 3, wherein:
a valve operation of the valves determines, for each liquid output flow path, a dispense volume of liquid dispensed from the corresponding outlet; and
the controller is configured to control the valve operation to control the dispense volumes of liquid respectively dispensed from the outlets.

5. The liquid dispensing device of claim 4, wherein the valve operation comprises one of:
periods of time during which the respective valves are open;
flow rates set by the respective valves.

6. The liquid dispensing device of claim 4, wherein the controller is configured to:
determine if the dispensed volumes equal target volumes or target volume ranges set for the respective outlets, based on the output signals received from one or more of the flow rate sensors; and
for any dispensed volume determined to be non-equal to the target volume or outside the target volume range set for the corresponding outlet, adjust the valve operation of the corresponding valve to achieve the target volume or target volume range.

7. The liquid dispensing device of claim 1, comprising a controller configured to control the steps of:
selecting selected outlets from which to dispense the liquid;
determining volumes of the liquid to be respectively dispensed from the selected outlets;
flowing the liquid through the inlet and the manifold, and into the conduits; and
dispensing the liquid according to the determined volumes from the corresponding selected outlets, by controlling the valves.

8. The liquid dispensing device of claim 1, comprising a controller configured to control the steps of:
dispensing liquid from one or more selected conduits of the plurality of conduits;
measuring respective flow rates of the liquid in the selected conduits;
for each selected conduit, determining if the measured flow rate deviates from a target flow rate or a target flow rate range set for the selected conduit;
for each selected conduit in which the measured flow rate is determined to deviate from the target flow rate the target flow rate range, adjusting a valve operation of the valve in the selected conduit.

9. The liquid dispensing device of claim 1, comprising at least one of the following features:
a reservoir communicating with the inlet, and a fluid moving device configured to flow liquid from the reservoir to the inlet;
a reservoir communicating with the inlet, and a fluid moving device configured to flow liquid from the reservoir to the inlet, wherein the fluid moving device comprises a pump;
a reservoir communicating with the inlet, and a fluid moving device configured to flow liquid from the reservoir to the inlet, wherein the fluid moving device comprises a pressure source configured to pressurize the reservoir to a controlled internal pressure;
a reservoir and a tube fluidly interconnecting the reservoir and the inlet, wherein the reservoir and the tube are configured to flow liquid via gravity feed.

10. A liquid dispensing system, comprising a plurality of the liquid dispensing devices of claim 1, wherein the liquid dispensing devices are horizontally stacked such that the outlets of the liquid dispensing devices are arranged in a two-dimensional array, and further comprising at least one of the following features:
The liquid dispensing system of claim 16, wherein, for each liquid dispensing device, at least one outlet of the liquid dispensing device is aligned with corresponding outlets of the other liquid dispensing devices along a straight line or a curved line;
wherein the outlets of each liquid dispensing device are horizontally spaced at a uniform distance from corresponding outlets of an adjacent one of the liquid dispensing devices;
wherein one or more outlets of the liquid dispensing devices are horizontally spaced at a non-uniform distance from the outlets of an adjacent one of the liquid dispensing devices;
comprising a plurality of liquid reservoirs respectively communicating with the inlets of the liquid dispensing devices;
wherein the liquid reservoirs are configured to be independently pressurized to individual internal pressures.

11. A liquid dispensing system, comprising:
a plurality of the liquid dispensing devices of claim 1, wherein the liquid dispensing devices are horizontally stacked such that the outlets of the liquid dispensing devices are arranged in a two-dimensional array; and
a controller configured to control the steps of:
selecting two or more selected liquid dispensing devices of the plurality of the liquid dispensing devices;
supplying two or more liquids to the respective inlets of the selected liquid dispensing devices; and
dispensing amounts of the two or more liquids from the respective outlets of the selected liquid dispensing devices into one or more containers, by controlling the valves of the selected liquid dispensing devices.

12. A liquid dispensing system, comprising:
the liquid dispensing device of claim 1; and
a stage movable along one or more axes, and configured to move a plurality of containers to and from the liquid dispensing device.

13. A method for dispensing a liquid, the method comprising:
providing a liquid dispensing device comprising a manifold, a plurality of conduits, and a plurality of valves respectively disposed in the conduits, wherein the manifold comprises an inlet and the plurality of conduits comprise a plurality of outlets, respectively;
providing a plurality of containers;
selecting selected containers of the plurality of containers to receive the liquid;
determining volumes of the liquid to be respectively dispensed into the selected containers, wherein the volume determined for at least one of the selected containers differs from the volume determined for at least one other of the selected containers;
flowing the liquid through the inlet and the manifold, and into the conduits; and
dispensing the liquid according to the determined volumes into the selected containers from corresponding outlets of the plurality of outlets, by controlling the valves.

14. The method of claim 13, wherein the plurality of containers is arranged as a two-dimensional array, the dispensing position is a first dispensing position, and the selected containers are first selected containers of a first column of the array, and the method further comprises:
after the dispensing into the first selected containers, moving the plurality of containers to a second dispensing position at which containers of a second column of the array are aligned with corresponding outlets of the plurality of outlets; and
dispensing additional determined volumes of the liquid into selected containers of the second column from corresponding outlets of the plurality of outlets.

15. The method of claim 13, wherein:
the liquid dispensing device is one of a plurality of liquid dispensing devices, each comprising a manifold, a plurality of conduits, and a plurality of valves respectively disposed in the conduits, wherein each manifold comprises an inlet and the conduits of each manifold comprise a plurality of respective outlets; and
the liquid dispensing devices are horizontally stacked such that the outlets of the liquid dispensing devices are arranged in a two-dimensional array.

16. The method of claim 15, comprising:
selecting two or more selected liquid dispensing devices of the plurality of the liquid dispensing devices; and
supplying two or more liquids to the respective inlets of the selected liquid dispensing devices, wherein:
the selecting comprises selecting selected containers of the selected liquid dispensing devices to receive the liquid;
the determining comprises determining volumes of the liquid to be respectively dispensed into the selected containers of the selected liquid dispensing devices; and
the dispensing comprises dispensing the two or more liquids according to the determined volumes from the respective outlets of the selected liquid dispensing devices into the selected containers, by controlling the valves of the selected liquid dispensing devices.

17. The method of claim 16, wherein the plurality of liquid dispensing devices comprises at least a first liquid dispensing device and a second liquid dispensing device, and further comprises one or more of the following features:
the dispensing comprises simultaneously dispensing a first liquid from the first liquid dispensing device and a second liquid from the second liquid dispensing device.
the dispensing comprises sequentially dispensing a first liquid from the first liquid dispensing device and a second liquid from the second liquid dispensing device.
the plurality of containers is arranged as a two-dimensional array, and the dispensing comprises: dispensing a first liquid from the first liquid dispensing device into one or more selected containers of a first column of the array; and dispensing a second liquid from the second liquid dispensing device into one or more selected containers of a second column of the array.
the plurality of containers is arranged as a two-dimensional array, and the dispensing comprises: dispensing a first liquid from the first liquid dispensing device into one or more selected containers of a selected column of the array; and dispensing a second liquid from the second liquid dispensing device into one or more of the selected containers of the same selected column.

18. The method of claim 13, comprising:
before the dispensing of the first liquid, aligning the selected column with the outlets of the first liquid dispensing device; and
before the dispensing of the second liquid, moving the plurality of containers to align the selected column with the outlets of the second liquid dispensing device.

19. A method for dispensing a liquid, the method comprising:
providing a liquid dispensing device comprising a manifold, a plurality of conduits, and a plurality of valves respectively disposed in the conduits, wherein the manifold comprises an inlet and the plurality of conduits comprise a plurality of outlets, respectively;
dispensing liquid from one or more selected conduits of the plurality of conduits;
measuring respective flow rates of the liquid in the selected conduits;
for each selected conduit, determining if the measured flow rate deviates from a target flow rate or a target flow rate range set for the selected conduit;
for each selected conduit in which the measured flow rate is determined to deviate from the target flow rate or the target flow rate range for that selected conduit, adjusting a valve operation of the valve in the selected conduit.

20. The method of claim 19, wherein the valve operation comprises one of:
periods of time during which the respective valves are open;
flow rates set by the respective valves.
